(19) United States
(12) Patent Application Publication
(10) Pub. No.: US 2024/0042436 A1
(43) Pub. Date: Feb. 8, 2024

(54) MICRO-DROPLET GENERATION METHOD AND GENERATION SYSTEM

(71) Applicant: FOSHAN ACXEL BOXIN TECH CO., LTD, Foshan (CN)

(72) Inventors: Hanbin MA, Foshan (CN); Subao SHI, Foshan (CN); Kai JIN, Foshan (CN); Longqian XU, Foshan (CN)

(21) Appl. No.: 18/259,197

(22) PCT Filed: Nov. 23, 2021
(86) PCT No.: PCT/CN2021/132216

§ 371 Date: Jun. 23, 2023

(30) Foreign Application Priority Data
Dec. 24, 2020 (CN) 202011549220.1
Dec. 24, 2020 (CN) 202011552355.3
Dec. 24, 2020 (CN) 202011552418.5
Dec. 24, 2020 (CN) 202011552491.2
Oct. 29, 2021 (CN) 202111268389.4
Nov. 5, 2021 (CN) 202111302971.8

(51) Int. Cl. B01L 3/00

(52) U.S. Cl. CPC B01L 3/50273; B01L 3/502792; B01L 2300/0645; B01L 2300/0819

(57) ABSTRACT

A micro-droplet generation method and generation system, capable of quickly preparing a large quantity of micro-droplets. The droplet generation time is greatly shortened, operations are simple and convenient, high-precision micro-pumps and other devices are not required, the system cost is reduced, the expansion capability is high, and more micro-droplets or multiple samples can be separated by expanding the size of a micro-fluidic chip. The volume and density of the formed droplets can be precisely adjusted by controlling a gap between an upper polar plate and a lower polar plate, and the quantity, the size of the area and the positions of attraction points. Provided are the micro-droplet generation method and the micro-droplet generation system capable of quickly forming high-density micro-droplets and accurately controlling the volume and density of the formed high-density micro-droplets.

### FIELD OF THE INVENTION

The invention relates to the technical field of droplet control, in particular to a micro-droplet generating method and a micro-droplet generating system.

### BACKGROUND OF THE INVENTION

Generating uniform droplets from a certain volume of liquid is a crucial challenge in microfluidic technology and a crucial step in many application fields including digital polymerase chain reaction (ddPCR), digital loop-mediated isothermal amplification (dLAMP), digital enzyme-linked immunoassay (dELISA), single-cell omics and the like. At present, the technical means for generating nanoliter droplets with high throughput mainly comprises a droplet microfluidic technology and a micro-well microfluidic technology, and the representations of the droplet microfluidic technology comprise Bio-Rad and 10× Genomics. Droplet microfluidic technology is characterized by that it utilizes high-precision micropump to control oil, by using a high-precision micropump to control the oil and using a cross-shaped structure to continuously squeeze the sample liquid to generate a large number of micro-droplets at the level of picoliters to nanoliters. The high throughput generation of nanoliter liquid droplets depends on the precise control of the high-precision micropump pressure and the high-precision chip processing technology based on MEMS. However, the generated droplets are still stored together in the same container. During detection, each droplet needs to be detected one by one through the micro-runner, leading to high equipment costs. A representative of a complex microwell microfluidic system is Thermo Fisher. Said technology is characterized by that it utilizes mechanical force to coat sample liquid on the microwell array so that the samples are uniformly distributed in each of the microwells. The micro-well microfluidic technology based on micro-well microfluidic control for forming micro-droplets from picoliter to nanoliter generally needs to uniformly coat reagents on the surface of a micro-well array by mechanical force, and then the inert medium liquid is used for filling the upper surface and the lower surface of the micro-well. The method has the defects of relatively complex operation flow, low automation degree, low experiment throughput and long sample preparation time.

Digital microfluidic devices are another means of high throughput droplet generation due to their ability to independently manipulate each droplet. Both WO 2016/170109 A1 and U.S. Pat. No. 20200061620S50 describe a method of generating a large number of droplets based on a digital microfluidic platform. However, the existing method for generating nanoliter droplets with high throughput using digital microfluidic technology primarily relies on controlling large droplets to generate micro-droplets, which are then conveyed to corresponding positions. This method suffers from several drawbacks, including low speed of micro-droplet generation and extended sample preparation time.

### SUMMARY OF THE INVENTION

In light of this, there is a need for a micro-droplet generating method and system that can produce micro-droplets at a relatively fast speed while maintaining stability and controllability.

A micro-droplet generating system comprises a microfluidic chip and a droplet driving unit connected to the microfluidic chip. The microfluidic chip comprises an upper electrode plate and a lower electrode plate, with a fluid channel layer formed between them. At least one of the plates features multiple suction points designed to adsorb liquid. The droplet driving unit is responsible for propelling the injected liquid to flow within the fluid channel layer, resulting in the formation of liquid micro-droplets at the suction point's location.

In one embodiment, the upper electrode plate is comprised of an upper plate, a conductive layer, and a first hydrophobic layer arranged sequentially. On the other hand, the lower plate consists of a second hydrophobic layer, a dielectric layer, an electrode layer, and a substrate arranged in a sequence. The first and second hydrophobic layers are oppositely arranged, with the fluid channel layer formed between them. The electrode layer contains an array of multiple electrodes.

One embodiment of the invention involves forming the suction point using electrodes that are actuated by the electrode layer. Adjacent actuated electrodes are then arranged at intervals through the use of closed electrodes.

In one embodiment of the invention, the upper electrode plate forms a hydrophilic point array on one side of the first hydrophobic layer far away from the conductive layer. The hydrophilic points of the hydrophilic point array are the suction points, and the adjacent hydrophilic points are arranged at intervals.

In one embodiment of the present invention, the electrode of the electrode layer is hexagonal and/or square in shape.

In one embodiment of the present invention, the electrode layer includes a plurality of square electrodes arranged in an array and a plurality of hexagonal electrodes arranged in an array.

In one embodiment of the invention, the electrode layer comprises a plurality of hexagonal electrodes arranged in an array and a plurality of square electrodes arranged in an array and positioned on two sides of the plurality of hexagonal electrodes arranged in an array.

In one embodiment of the invention, the electrode layer comprises a plurality of regular-side electrodes arranged in an array and a plurality of hexagonal electrodes arranged in an array and positioned on two sides of the plurality of regular-side electrodes arranged in an array.

In one embodiment of the invention, the side length of the hexagonal electrode is 50 μm-2 mm, and the side length of the square electrode is 50 μm-2 mm.

In one embodiment of the invention, the electrode layer comprises a plurality of first square electrodes arranged in an array, a plurality of first hexagonal electrodes arranged in an array, a plurality of second square electrodes arranged in an array, and a plurality of second hexagonal electrodes in an array connected in sequence.

In one embodiment of the invention, the electrode layer comprises a plurality of first hexagonal electrodes arranged in an array, a plurality of second hexagonal electrodes arranged in an array, and a plurality of square electrodes in an array, which are sequentially connected.

In one embodiment of the invention, the side length of the first square electrode or the square electrode is 50 μm-2 mm, the side length of the second square electrode is ⅕-½ of the side length of the first square electrode, the side length of the first hexagonal electrode is 50 μm-2 mm, and the side length of the second hexagonal electrode is ⅕-½ of the side length of the first hexagonal electrode.

In one embodiment of the invention, the droplet driving unit is an electrode driving unit connected to the electrode layer and used for controlling opening and closing of the electrode of the electrode layer so as to control the flow of liquid injected into the fluid channel layer in the fluid channel layer and form liquid micro-droplets at the position of the suction point.

In one embodiment of the invention, a liquid injection hole is formed in the center of the microfluidic chip. The liquid injection hole is used for injecting liquid into the fluid channel layer, the microfluidic chip is also provided with a plurality of liquid drain holes. The liquid drain hole is used for discharging excess liquid from the microfluidic chip. The droplet driving unit is a rotary driving unit, and the rotary driving unit is used for driving the microfluidic chip to rotate so that liquid injected into the fluid channel layer forms micro-droplets at the suction point in a spin-coating mode.

In one embodiment of the invention, the rotation driving unit drives the microfluidic chip to rotate at a rotation speed greater than 0 rpm and less than or equal to 1000 rpm.

In one embodiment of the invention, the electrode is hexagonal, the side length of the electrode is 50 μm-2 mm, and the distance between the first hydrophobic layer and the second hydrophobic layer is 5 μm-600 μm.

In one embodiment of the invention, the microfluidic chip is provided with a first sample injection hole and a first sample drain hole. The first sample injection hole and the first sample drain hole are arranged on a first diagonal line of the microfluidic chi. The droplet driving unit includes a first micropump and a third micropump. The first micropump is connected to the first sample injection hole and is used for injecting liquid into the fluid channel layer so that the fluid channel layer is filled with the liquid. And the third micropump is connected to the first sample drain hole and is used for extracting the liquid or gas flowing out of the first sample drain hole so as to form micro-droplets at the suction point.

In one embodiment of the invention, the microfluidic chip is also provided with a second sample injection hole and a second sample drain hole. The second sample injection hole and the second sample drain hole are arranged on a second diagonal line of the microfluidic chip. The droplet driving unit further includes a second micropump and a fourth micropump. The second micropump is connected to the second sample injection hole and used for injecting medium into the fluid channel layer, and the fourth micropump is connected to the second sample drain hole and used for extracting excess liquid or medium flowing out of the second sample drain hole so that liquid micro-droplets is wrapped by the medium formed at the position of the suction point.

In one embodiment of the invention, the thickness of the upper plate is 0.05 mm-1.7 mm, the thickness of the substrate is 0.05 mm-1.7 mm, the thickness of the conductive layer is 10 nm-500 nm, the thickness of the dielectric layer is 50 nm-1000 nm, the thickness of the electrode layer is 10 nm-1000 nm, the thickness of the first hydrophobic layer is 10 nm-200 nm, and the thickness of the second hydrophobic layer is 10 nm-200 nm.

A micro-droplet generating system comprises a microfluidic chip consisting of an upper electrode plate and a lower electrode plate, a fluid channel layer is formed between the upper electrode plate and the lower electrode plate. At least one of said upper plate and said lower plate form a plurality of suction points. The suction point is used for adsorbing liquid. An included angle is formed between the plane of the upper electrode plate and the plane of the lower electrode plate. The upper electrode plate is provided with a plurality of sample injection holes, the sample injection hole is positioned at the edge of the upper electrode plate, and the sample injection hole is used for injecting the liquid. Said fluid channel layer comprising a first end and a second end disposed opposite each other, the height of the first end of the fluid channel layer being less than the height of the second end of the fluid channel layer. When liquid is injected into the first end of the fluid channel layer through the sample injection hole, the liquid moves from the first end to the second end under the action of surface tension and forms micro-droplets at the suction point.

In one embodiment of the present invention, the included angle between the upper plate and the lower plate is greater than 0 degrees and less than 3 degrees.

In one embodiment of the present invention, at the first end, the distance between the upper plate and the lower plate is 0 μm to 200 μm.

In one embodiment of the invention, the upper electrode plate comprises an upper plate, a conductive layer and a first hydrophobic layer which are sequentially arranged. The lower plate comprises a second hydrophobic layer, a dielectric layer, an electrode layer and a substrate which are sequentially arranged. The first hydrophobic layer and the second hydrophobic layer are oppositely arranged, and the fluid channel layer is formed between the first hydrophobic layer and the second hydrophobic layer. The electrode layer comprises a plurality of electrodes arranged in an array.

In one embodiment of the invention, the suction point is formed by the electrodes actuated by the electrode layer, and adjacent actuated electrodes are arranged at intervals through the electrodes which are not actuated.

In one embodiment of the invention, the upper electrode plate forms a hydrophilic point array on one side of the first hydrophobic layer far away from the conductive layer, and the hydrophilic points of the hydrophilic point array are the suction points. The adjacent hydrophilic points are arranged at intervals.

In one embodiment of the present invention, the electrode of the electrode layer is hexagonal and/or square in shape.

A method for generating micro-droplets comprises the steps of:
S1, providing a microfluidic chip, said microfluidic chip comprising an upper plate and a lower plate, said upper plate and said lower plate forming a fluid channel layer therebetween;
S2, forming a plurality of suction points on at least one of said upper plate and said lower plate, said suction points for adsorbing liquid;
S3, injecting liquid into the fluid channel layer;
S4, driving the liquid to flow in the fluid channel layer to form micro-droplets at multiple suction points of the microfluidic chip.

In one embodiment of the invention, the upper plate comprises an upper plate, a conductive layer and a first hydrophobic layer which are sequentially stacked. The lower plate comprises a second hydrophobic layer, a dielectric layer, an electrode layer and a substrate which are sequentially stacked. The electrode layer comprises a plurality of electrodes arranged in an array, and the fluid channel layer is formed between the first hydrophobic layer and the second hydrophobic layer;
Said step S2 includes the following steps: opening several electrodes of the described electrode layer, the actuated electrodes can be formed into the described suction point, and between adjacent actuated electrodes the unactuated electrodes can be used for spacing arrangement.

In one embodiment of the invention, the upper plate comprises an upper plate, a conductive layer and a first hydrophobic layer which are sequentially stacked; The lower plate comprises a second hydrophobic layer, a dielectric layer, an electrode layer and a substrate which are sequentially stacked; The electrode layer comprises a plurality of electrodes arranged in an array, and the fluid channel layer is formed between the first hydrophobic layer and the second hydrophobic layer;
Said step S2 includes the following steps: utilizing laser or plasma to treat the hydrophobic coating layer at the required position of the first hydrophobic layer so as to form hydrophilic points on the first hydrophobic layer, the hydrophilic points are suction points, and the adjacent hydrophilic points are alternatively placed.

In one embodiment of the present invention, step S4 comprises the steps of:
S110, opening the electrodes of the first row to the P-th row so that the liquid forms large droplets at positions of the fluid channel layer corresponding to the electrodes of the first row to the P-th row, wherein P is a positive integer;
S120, keeping the electrodes of the suction points of the first row open, closing the other electrodes of the first row, simultaneously opening the electrodes of the (P+1)th row, driving the large droplets to move forward one row in the fluid channel layer, and forming micro-droplets at the suction points of the first row, at least one electrode being spaced between adjacent suction points;
S130, opening the electrodes holding the suction points of the second row, closing the other electrodes of the second row, simultaneously, opening the electrodes of the (P+2)th row, driving the large liquid droplets to move forward in the fluid channel layer by another row, and forming liquid micro-droplets at the suction points of the second row, at least one electrode being spaced between adjacent suction points, the suction points of the first row and the suction points of the second row being in different columns;
S140, opening the electrodes for holding the suction points of the n-th row, closing the other electrodes of the n-th row, simultaneously, opening the electrodes of the (P+n)th row, driving the large liquid droplets to move forward in the fluid channel layer by another row, and forming liquid micro-droplets at the suction points of the n-th row, wherein at least one electrode is spaced between adjacent suction points, the suction points of the n-th row and the suction points of the (n−1)th row are in different columns, wherein n is a positive integer greater than 3;
S150, repeating S140 to form multiple micro-droplets on the microfluidic chip until the large droplets are depleted.

In one embodiment of the present invention, step S4 comprises the steps of:
S210, opening the electrodes of the first row to the P-th row, the liquid in the fluid channel layer forming large droplets on the electrodes of the first row to the P-th row of the electrode layer, wherein P is a positive integer;
S220, closing the electrodes of the first row while opening the electrodes of the (P+1)th row, driving the large droplets to move forward by one row in the fluid channel layer to form micro-droplets at the hydrophilic point of the first row;
S230, closing the electrodes of the second row while opening the electrodes of the (P+2)th row to drive the large droplets to move forward one row in the electrode layer to form micro-droplets at the hydrophilic point of the second row;
S240, closing the electrodes of the n-th row while opening the electrodes of the (P+n)th row, driving the large droplets to move forward another row on the electrode layer, and forming micro-droplets at the hydrophilic point of the n-th row, wherein n is a positive integer greater than 3;
S250, repeating S240 to form multiple droplets on the microfluidic chip until the large droplets are depleted.

In one embodiment of the present invention, step S4 includes the step of rotating the microfluidic chip, the liquid in the fluid channel layer forming micro-droplets at locations corresponding to the plurality of actuated electrodes.

In one embodiment of the present invention, step S4 includes the step of rotating the microfluidic chip, the liquid in the fluid channel layer forming micro-droplets at locations corresponding to a plurality of the hydrophilic points.

In one embodiment of the present invention, in step S4, the rotational speed of rotating the microfluidic chip is greater than 0 rpm and less than or equal to 1000 rpm.

In one embodiment of the present invention, in step S3, the liquid is injected from a liquid injection hole in the center of the microfluidic chip.

In one embodiment of the invention, the micro-droplet generating method further comprises the step of stopping rotating the microfluidic chip when excess liquid flows out of the fluid channel layer.

In one embodiment of the invention, an included angle is formed between the plane of the upper electrode plate and the plane of the lower electrode plate, said upper plate being provided with a plurality of sample injection holes at an edge of said upper plate, said sample injection holes for injecting a sample, said fluid channel layer including opposing first and second ends, said first end of said fluid channel layer having a height less than said second end of said fluid channel layer;
In step S3, the liquid is injected into the first end of the fluid channel layer through the sample injection hole, when the liquid is injected into the fluid channel layer, the liquid moves from the first end to the second end under the action of surface tension, and the liquid forms micro-droplets at a position corresponding to the suction point.

In one embodiment of the present invention, in step S3, the liquid is injected at a rate of 1 μL/s to 10 μL/s.

In one embodiment of the invention, at the first end, the distance between the upper electrode plate and the lower electrode plate is 0-200 μm, and the included angle between the upper electrode plate and the lower electrode plate is larger than 0 degrees and smaller than 3 degrees.

In one embodiment of the invention, the microfluidic chip is provided with a first sample injection hole and a first sample drain hole, the first sample drain hole and the first sample injection hole are arranged on a first diagonal line of the microfluidic chip, the first sample injection hole is communicated with a first micropump, and the first sample drain hole is communicated with a third micropump;
In step S3, the liquid is injected into the fluid channel layer via the first sample injection hole using a first micropump. A third micropump is used for pumping liquid flowing out of the first sample drain hole.

In one embodiment of the invention, the microfluidic chip is also provided with a second sample injection hole and a second sample drain hole, the second sample drain hole and the second sample injection hole are arranged on a second diagonal line of the microfluidic chip, and the second sample injection hole is communicated with a second micropump. The second sample drain hole is communicated with a fourth micropump;

In step S4, a medium is injected into the fluid channel layer via the second sample injection hole using a second micropump; Pushing said liquid out of said suction point by said medium, said liquid leaves a micro-droplet at a location corresponding to said suction point, said medium wrapping said micro-droplet; A fourth micropump is adopted to pump the medium flowing out of the second sample drain hole.

In one embodiment of the invention, the volume and density of the micro-droplets formed by the microfluidic chip are adjusted by controlling and adjusting the gap between the upper electrode plate and the lower electrode plate, and the number, area and position of the suction points.

A method for generating micro-droplets comprises the steps of:
Providing a microfluidic chip including an upper plate and a lower plate, a fluid channel layer formed between the upper plate and the lower plate; The lower plate includes an electrode layer including a plurality of electrodes arranged in an array;
Forming a plurality of suction points in the lower plate, the suction points for adsorbing liquid; The suction point is formed by electrodes actuated by the electrode layer, and adjacent actuated electrodes are arranged at intervals through the electrodes which are not actuated;
Injecting a liquid sample into the fluid channel layer, and forming n1 micro-droplets of the liquid sample at a position corresponding to the suction point by controlling opening and closing of the electrode;
Controlling the opening and closing of the electrode to make each of the formed n1 micro-droplets form n2 micro-droplets at the position of the suction point;
Controlling the opening and closing of the electrode to make each of the formed n2 micro-droplets form n3 micro-droplets at the position of the suction point;
Repeatedly controlling opening and closing of the electrodes to form a target number of micro-droplets;
Wherein n1, n2, n3 are positive integers greater than or equal to 2.

In one embodiment of the present invention, a liquid sample is injected into the fluid channel layer, and the liquid sample forms two droplets at a position corresponding to the suction point by controlling the opening and closing of the electrode;
Controlling the opening and closing of the electrode to make each of the two formed droplets form two droplets at the position of the suction point;
Controlling the opening and closing of the electrode to make each of the two formed droplets form two droplets at the position of the suction point;
Repeatedly controlling the opening and closing of the electrodes to form a target number of micro-droplets.

In one embodiment of the invention, a liquid sample is injected into the fluid channel layer, and the liquid sample forms three droplets at a position corresponding to the suction point by controlling the opening and closing of the electrode;
Controlling the opening and closing of the electrode to make each of the formed three micro-droplets form three micro-droplets at the position of the suction point;
Controlling the opening and closing of the electrode to make each of the formed three micro-droplets form three micro-droplets at the position of the suction point;
Repeatedly controlling the opening and closing of the electrodes to form a target number of micro-droplets.

In one embodiment of the present invention, a liquid sample is injected into the fluid channel layer, and by controlling the opening and closing of the electrode, the liquid sample forms four droplets at a position corresponding to the suction point;
Controlling the opening and closing of the electrode to make each of the four formed droplets form four droplets at the position of the suction point;
Controlling the opening and closing of the electrode to make each of the four formed droplets form four droplets at the position of the suction point;
Repeatedly controlling the opening and closing of the electrodes to form a target number of micro-droplets.

In one embodiment of the invention, the electrode is square or hexagonal.

In one embodiment of the invention, The upper electrode plate comprises an upper plate, a conductive layer and a first hydrophobic layer which are sequentially stacked; The lower plate further comprises a second hydrophobic layer and a dielectric layer, wherein the second hydrophobic layer, the dielectric layer and the electrode layer are sequentially stacked; The first hydrophobic layer and the second hydrophobic layer are oppositely arranged, and the fluid channel layer is formed between the first hydrophobic layer and the second hydrophobic layer.

In one embodiment of the present invention, the side length of the electrode is 50 μm to 2 mm.

In one embodiment of the present invention, the distance between the first hydrophobic layer and the second hydrophobic layer is 5 μm to 600 μm.

The micro-droplet generating method and the micro-droplet generating system in this invention enable the quick preparation of a large number of micro-droplets. The droplet generation time is greatly reduced, and the operation process is simplified, eliminating the need for high-precision micropumps. The system is cost-effective and highly scalable, with the size of the microfluidic chip can be expanded to separate more microdroplets or multiple groups of samples. By controlling and adjusting the gap between the upper and lower electrode plates and the number, area, and position of the suction points, the volume and density of the formed micro-droplets can be accurately adjusted. So that the invention provides a micro-droplet generating method and a micro-droplet generating system which can quickly form high-density micro-droplets and can accurately control the volume and the density of the formed high-density micro-droplets.

The micro-droplet generating method and the micro-droplet generating system are high in expansion capacity, further, more micro-droplets can be separated by expanding the chip size or multiple groups of samples can be separated. Since the electrode layer includes at least two electrodes of different shapes arranged in an array, by controlling the opening or closing of the electrodes, large droplets can form micro-droplets on a plurality of arrayed electrodes in one shape, and related experiments of the micro-droplets can be completed on a plurality of arrayed electrodes in the other shape, so that cross infection of liquid samples can be avoided.

### DESCRIPTION OF THE DRAWINGS

FIG. 1 is a schematic cross-sectional view of a microfluidic chip of the micro-droplet generation system of Embodiment 1 of the present invention;

FIG. 2 is a schematic diagram of the micro-droplet generation system of Embodiment 1 of the present invention;

FIG. 3 is a flow chart of a micro-droplet generation method employing the micro-droplet generation system of FIG. 1;

FIG. 4 is a schematic flow diagram of the movement of a large droplet to form a micro-droplet;

FIG. 5 is a schematic flow diagram of the movement of a large droplet to form a plurality of micro-droplets;

FIG. 6 is a flow diagram illustrating the movement of a large droplets of Embodiment 1 of the present invention on a microfluidic chip to form a plurality of micro-droplets;

FIG. 7 is a schematic diagram of an actual experiment of the movement of a large droplets of Embodiment 1 of the present invention on a microfluidic chip to form a plurality of micro-droplets;

FIG. 8 is a schematic diagram of the movement of a large droplets of Embodiment 1 of the present invention on a microfluidic chip to form a plurality of micro-droplets;

FIG. 9 is a flow diagram of a micro-droplet generation method of the micro-droplet generation system of Embodiment 1 of the present invention;

FIG. 10 is a schematic diagram of a micro-droplet generation method of the micro-droplet generation system of Embodiment 2 of the present invention;

FIGS. 11-13 are flow block diagrams of a micro-droplet generation method of the micro-droplet generation system of Embodiment 2 of the present invention;

FIG. 14 is a schematic diagram of the micro-droplet generation system of Embodiment 3 of the present invention;

FIG. 15 is a schematic cross-sectional view of a microfluidic chip of the micro-droplet generation system of Embodiment 3 of the present invention;

FIGS. 16 and 17 are schematic views of a micro-droplet generation method of the micro-droplet generation system of Embodiment 3 of the present invention;

FIG. 18 is a schematic diagram of the composition structure of the mixed solution in digital ELISA;

FIG. 19 is a schematic diagram of a digital ELISA workflow implemented using a micro-droplet generation system;

FIGS. 20 and 21 are flow block diagrams of a micro-droplet generation method of the micro-droplet generation system of Embodiment 3 of the present invention;

FIGS. 22-25 are schematic views of a micro-droplet generation method of the micro-droplet generation system of Embodiment 4 of the present invention;

FIGS. 26 and 27 are flow block diagrams of a micro-droplet generation method of the micro-droplet generation system of Embodiment 4 of the present invention;

FIG. 28 is a schematic cross-sectional view of a microfluidic chip of the micro-droplet generation system of Embodiment 5 of the present invention illustrating the micro-droplet generation process;

FIG. 29 is a schematic diagram of the first configuration of the electrode layer of Embodiment 5 of the present invention;

FIG. 30 is a schematic diagram of liquid movement to form micro-droplets when an electrode layer of the first configuration is employed in Embodiment 5 of the present invention;

FIG. 31 is a schematic diagram of the second configuration of the electrode layer of Embodiment 5 of the present invention;

FIG. 32 is a schematic diagram of liquid movement to form micro-droplets when an electrode layer of a second configuration is employed in Embodiment 5 of the present invention;

FIG. 33 is a schematic diagram of liquid movement to form micro-droplets in Embodiment 5 of the present invention illustrating the process of sorting cell experiments using the micro-droplet generation method;

FIG. 34 is a schematic diagram of liquid movement to form micro-droplets in Embodiment 5 of the present invention illustrating the process of forming picoliter micro-droplets;

FIG. 35 is a schematic flow diagram of the micro-droplet generation method of Embodiment 5 of the present invention;

FIG. 36 is a schematic flow diagram of the micro-droplet generation method of Embodiment 6 of the present invention;

FIG. 37 is a schematic diagram of generating micro-droplets by moving a liquid sample according to the first method presented in Embodiment 6 of the present invention;

FIG. 38 is a schematic diagram of generating micro-droplets by moving a liquid sample according to the first method presented in Embodiment 6 of the present invention, illustrating the process of forming picoliter micro-droplets;

FIG. 39 is a schematic diagram of an experiment of generating micro-droplets by moving a liquid sample according to the first method presented in Embodiment 6 of the present invention;

FIG. 40 is a schematic view of generating micro-droplets by moving a liquid sample according to the second method presented in Embodiment 6 of the present invention;

FIG. 41 is a schematic view of generating micro-droplets by moving a liquid sample according to the third method presented in Embodiment 6 of the present invention;

FIG. 42 is a schematic diagram of generating micro-droplets by moving a liquid sample according to the fourth method presented in Embodiment 6 of the present invention.

Reference numerals refer to a microfluidic chip 100; An upper electrode plate 10; An upper plate 11; A conductive layer 12; A first hydrophobic layer 13; A hydrophilic point 131; An injection hole 132; A drain hole 133; A first sample injection hole 134; A first sample drain hole 135; A second sample injection hole 136; A second sample drain hole 137; A lower electrode plate 20; A second hydrophobic layer 21; A dielectric layer 22; An electrode layer 23; An electrode 24; An actuated electrode 241; An unactuated electrode 242; A square electrode 243; A hexagonal electrode 244; A first square electrode 2431; A second square electrode 2432; A first hexagonal electrode 2441; A second hexagonal electrode 2442; A substrate 25; Fluid channel layer 101; Liquid 200; A micro-droplet 201; A cell 202; A first arrow 31; A second arrow 32; A first micropump 41; A second micropump 42; A third micropump 43; A fourth micropump 44; A medium 300; A mixed solution 50; A microbead 51; A first microbead 511; A second microbead 512; Capture antibody 52; Target antigen 53; Fluorescently labeled antibody 54.

### DETAILED DESCRIPTION OF THE PREFERRED EMBODIMENTS

For purposes, aspects, and advantages of the present application, it is to be understood that the following detailed description of the application, taken in conjunction with the accompanying drawings and embodiments, is intended to illustrate only the specific embodiments described herein and not to limit the present application.

### Embodiment 1

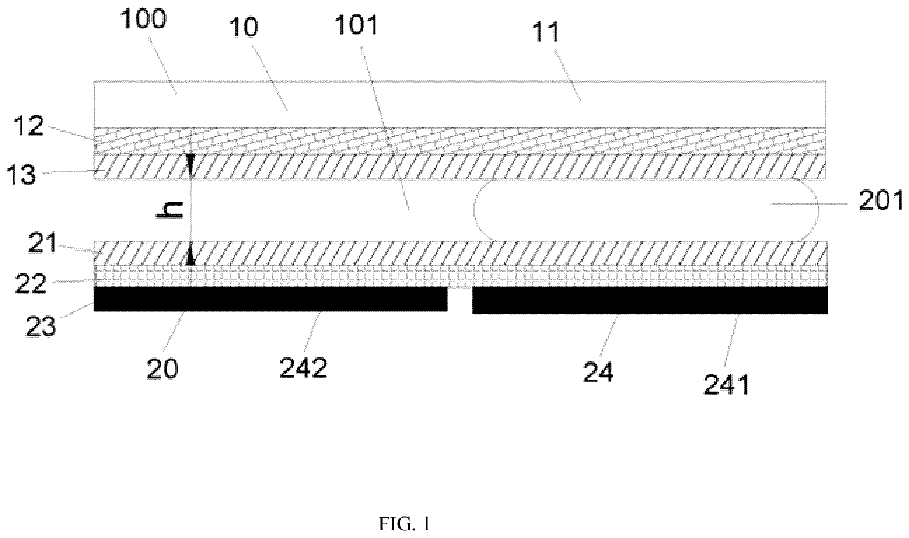

As shown in FIGS. 1-9, specific structures and methods of micro-droplet generation of the micro-droplet generation system according to Embodiment 1 of the present application are specifically illustrated.

Specifically, the micro-droplet generating system comprises a microfluidic chip 100 and a droplet driving unit connected to the microfluidic chip 100. The microfluidic chip 100 includes an upper electrode plate 10 and a lower electrode plate 20, a fluid channel layer 101 is formed between the upper electrode plate 10 and the lower electrode plate 20, and at least one of the upper electrode plate 10 and the lower electrode plate 20 forms a plurality of suction points for adsorbing a liquid 200; The droplet driving unit is used for driving the liquid 200 injected into the fluid channel layer 101 to flow in the fluid channel layer 101 so as to form micro-droplets 201 at the position of the suction point.

More specifically, as shown in FIG. 1, the upper electrode plate 10 comprises an upper plate 11, a conductive layer 12 and a first hydrophobic layer 13 which are sequentially arranged, the lower electrode plate 20 comprises a second hydrophobic layer 21, a dielectric layer 22 and an electrode layer 23 which are sequentially arranged; The first hydrophobic layer 13 and the second hydrophobic layer 21 are oppositely arranged, and a fluid channel layer 101 is formed between the first hydrophobic layer 13 and the second hydrophobic layer 21; At least one of the upper electrode plate 10 and the lower electrode plate 20 forms a plurality of suction points for adsorbing the liquid 200, and the electrode layer 23 includes a plurality of electrodes 24 arranged in an array.

In this embodiment, the droplet driving unit is the electrode driving unit connected to the electrode layer 23 for controlling the opening and closing of the electrode 24 of the electrode layer 23 so as to control the flow of the liquid 200 injected into the fluid channel layer 101 in the fluid channel layer 101 to form micro-droplets 201 at the position of the suction point.

It will be appreciated that the sizes of the plurality of suction points may be the same or different and that the number and location may be set as desired to simultaneously generate micro-droplets 201 of the same or different volumes

It will also be appreciated that, By controlling the gap of the fluid channel layer 101 and the number, location and area of the suction points, The volume and the density of the micro-droplets 201 formed on the microfluidic chip 100 can be correspondingly adjusted, so that the invention provides a micro-droplet generation method and a micro-droplet generation system which can quickly form high-density micro-droplets and can accurately control the volume and the density of the formed high-density micro-droplets.

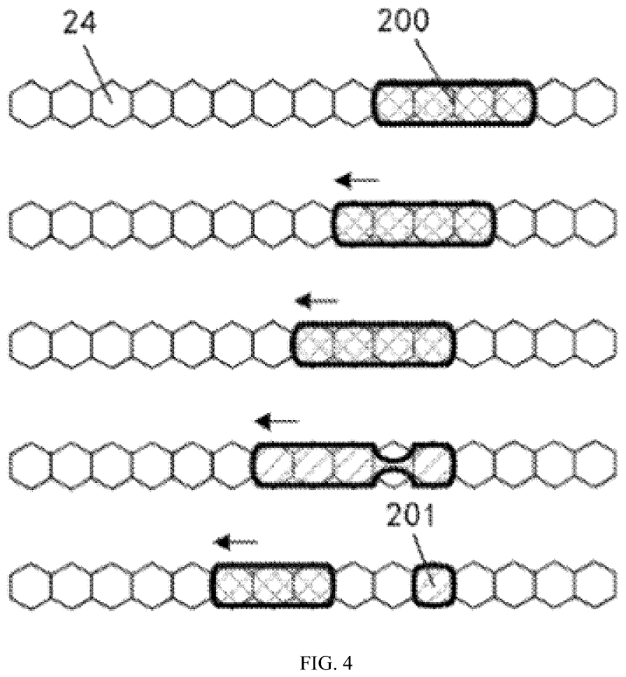

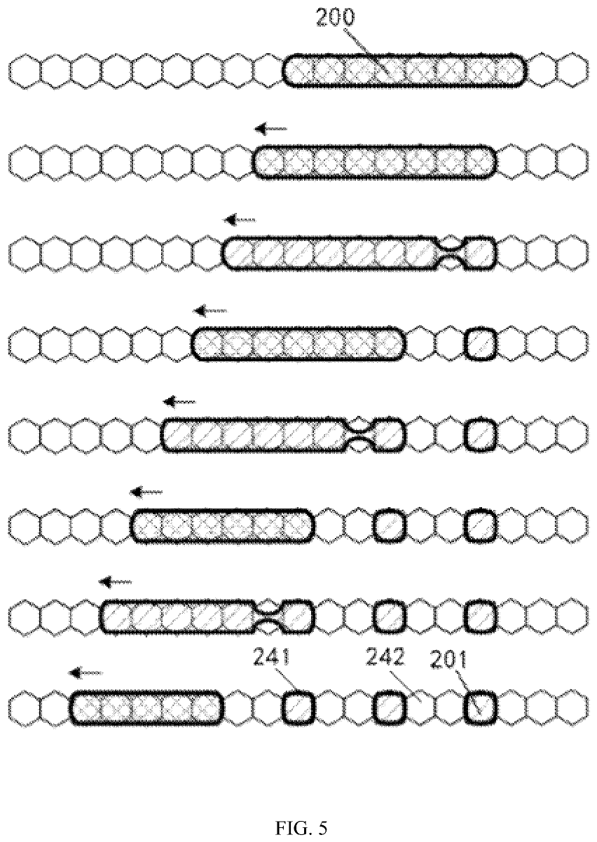

Alternatively, as shown in FIGS. 4 and 5, the suction point is formed by actuated electrodes 241 of the electrode layer 23, with adjacent actuated electrodes 241 being spaced apart by unactuated electrodes 242.

Alternatively, the electrode 24 of the electrode layer 23 is hexagonal or square. In this embodiment, the shape of the electrode 24 is hexagonal. When the shape of the electrode 24 is hexagonal, the contact surface is enlarged, and the utilization rate of the plate of the electrode 24 is higher. As can be appreciated, the shape of the electrode 24 can also be a combination of a hexagon and a square, or any other shape or any combination of shapes. The present application is not limited in this respect.

Alternatively, the side length of the hexagonal electrode is 50 μm to 2 mm, the side length of the square electrode is 50 μm to 2 mm, and the size of the electrode 24 is not limited.

The micro-droplet generating system, by adding large droplets to the fluid channel layer 101, then the opening or closing of the electrode 24 of the electrode layer 23 is controlled by the electrode driving unit, thereby controlling the large droplets added to the fluid channel layer 101 to flow in a coating-like manner on the surface of the electrode layer 23. The micro-droplets 201 are formed at a plurality of suction points of the fluid channel layer 101 so that the droplet generation time can be greatly shortened, and the droplet generation stability can be improved. The size of generated droplets can be dynamically adjusted according to requirements, the operation process is simple and convenient, high-precision micropumps and other equipment are not needed, and the system cost is reduced. The system has strong expansibility and can separate more micro-droplets or several groups of samples by expanding microfluidic size.

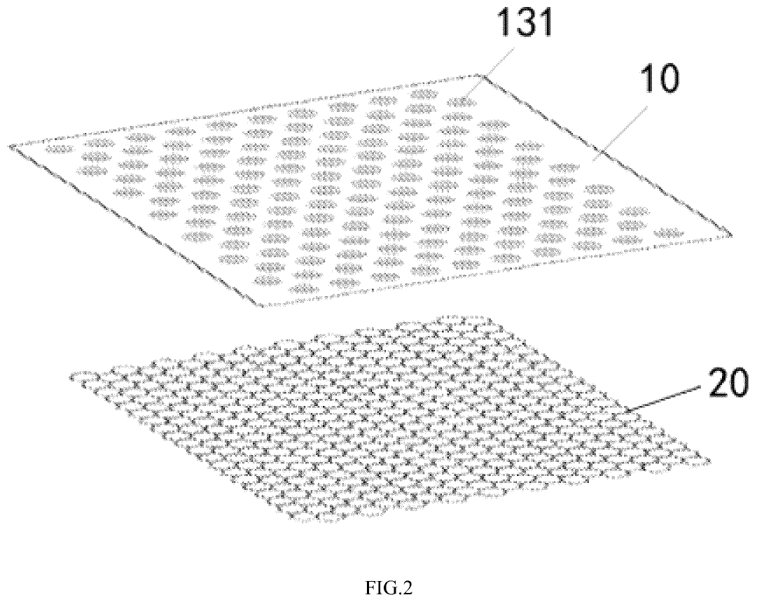

Alternatively, as shown in FIG. 2, in a variant embodiment of the present embodiment, the suction points may also be formed by hydrophilic points 131. Specifically, the upper electrode plate 10 has a hydrophilic point array formed on one side of the first hydrophobic layer 13 remotes from the conductive layer 12, the hydrophilic points 131 of the hydrophilic point array being the suction points, adjacent hydrophilic points 131 being spaced apart.

It should be understood that the array of hydrophilic points may also be formed on the second hydrophobic layer 21 or both the first hydrophobic layer 13 and the second hydrophobic layer 21 are provided with hydrophilic points 131, which is not limited in this application.

Referring to FIG. 2, by hydrophilic modification, forming a hydrophilic point array on the side of the first hydrophobic layer 13 remotes from the conductive layer 12. At least one electrode 24 is spaced between adjacent hydrophilic points 131, and the electrode driving unit is connected to the electrode layer 23. The electrode driving unit is used for driving large droplets to flow in the fluid channel layer 101, and the large droplets form micro-droplets 201 at the hydrophilic point 131. As can be appreciated, the volume of the micro-droplets 201 formed by the micro-droplet generation system is determined by the size of the gap h of the fluid channel layer 101 and the area of the hydrophilic point 131.

The micro-droplet generating system, by adding large droplets to the fluid channel layer 101, an electrode driving unit for driving the large droplets to flow in the fluid channel layer 101. As large droplets pass through the hydrophilic point 131, due to the hydrophilic action of the hydrophilic point 131, leaving micro-droplets 201 at hydrophilic point 131. In addition, the micro-droplet generating system does not need to separate micro-droplets 201 through the control electrode 24, so that the micro-droplet generating system is simpler and more convenient to operate, does not need high-precision micropumps and other equipment, is low in system cost and strong in expansibility, and can separate more micro-droplets or separate a plurality of groups of samples by expanding the microfluidic size.

It will be appreciated that the present application also provides a micro-droplet generation method of the micro-droplet generation system shown in FIG. 1, comprising the steps of:

The opening or closing of the electrode 24 of the electrode layer 23 is controlled so that when large droplets flow through the electrode layer 23, micro-droplets 201 are formed at a plurality of suction points of the electrode layer 23, respectively.

In the micro-droplet generating method, the opening or closing of the electrode 24 of the electrode layer 23 is controlled, so that when large droplets flow through the electrode layer 23, micro-droplets 201 are respectively formed at a plurality of suction points of the electrode layer 23, the droplet generating time can be greatly shortened, and the operation process is simple and convenient.

It will be appreciated that the sizes of the plurality of suction points may be the same or different to simultaneously generate micro-droplets 201 of different volumes.

Further, at least one electrode 24 is spaced from each other between the plurality of suction points, and at least one electrode 24 is spaced from each other between the plurality of suction points to prevent the micro-droplets 201 from bonding. Preferably, two electrodes 24 are spaced from each other between the plurality of suction points.

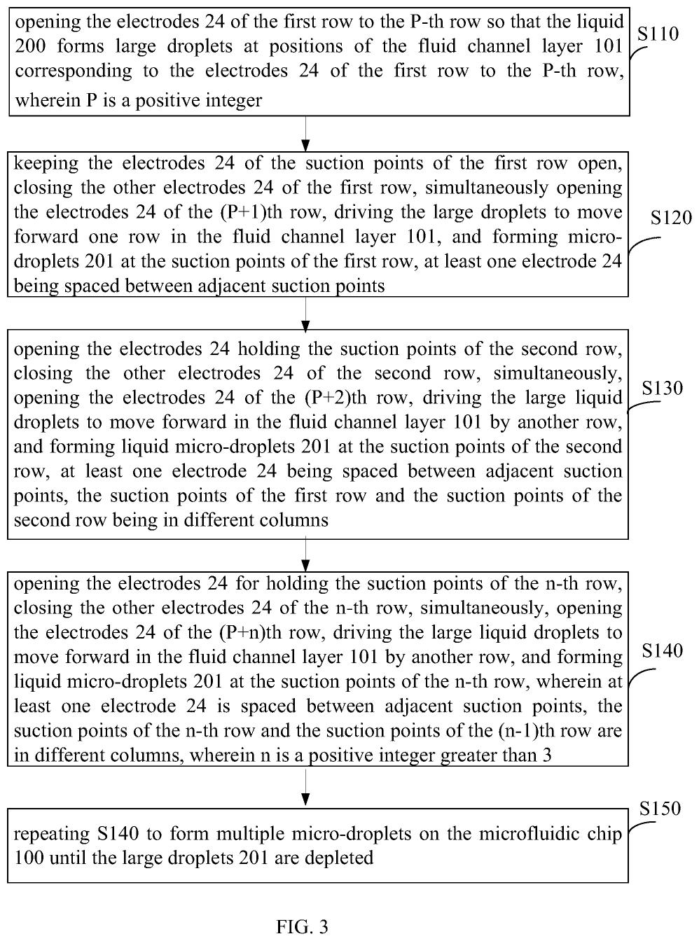

Specifically, referring to FIG. 3, the operation of controlling the opening or closing of the electrode 24 of the electrode layer 23 so that large droplets flow through the electrode layer 23 to form micro-droplets 201 at a plurality of suction points of the electrode layer 23, respectively, is as follows:
S110, opening the electrodes 24 of the first row to the P-th row so that the liquid 200 forms large droplets at positions of the fluid channel layer 101 corresponding to the electrodes 24 of the first row to the P-th row, wherein P is a positive integer;
S120, opening the electrodes 24 holding the suction points of the first row and closing the other electrodes 24 of the first row while opening the electrodes 24 of the (P+1)th row, driving the large droplets to move forward by one row in the fluid channel layer 101 and forming micro-droplets 201 at the suction points of the first row, at least one electrode 24 being spaced between adjacent suction points;
S130, the electrodes 24 holding the suction points of the second row are actuated, closing the other electrodes 24 of the second row, simultaneously, opening the electrodes 24 of the (P+2)th row, driving the large droplets to move forward in the fluid channel layer 101 for another row, and forming micro-droplets 201 at the suction points of the second row, at least one electrode 24 being spaced between adjacent suction points, the suction points of the first row and the suction points of the second row being in different columns;
S140, the electrodes 24 holding the suction points of the n-th row are actuated, closing the other electrodes 24 of the n-th row, simultaneously, opening the electrodes 24 of the (P+n)th row, driving the large liquid droplets to move forward in the fluid channel layer 101 by another row, and forming liquid micro-droplets 201 at the suction points of the n-th row, at least one electrode 24 being spaced between adjacent suction points, the suction points of the n-th row and the suction points of the (n−1)th row being in different columns, wherein n is a positive integer greater than 3;
S150, repeating S140 to form a plurality of micro-droplets 201 on the microfluidic chip 100 until the large droplets are depleted.

It will be appreciated that the specific operations of repeating S140 in S150 are: n is 3, and S140 is performed once; n is 4, executing S140 once; n is 5, and S140 is performed once, and so on, until the large droplet is depleted. That is, large droplets move sequentially from the first row to the n th row, and a plurality of micro-droplets 201 are formed in each of the first row to the n th row.

It will be appreciated that the “row” in the micro-droplet generation method described above may be designated by a “column”, i.e., large droplets move sequentially from the first column to the n th column, and a plurality of micro-droplets 201 are formed in each of the first column to the n th column.

In one embodiment, the volume of micro-droplets 201 is controlled by adjusting the distance between the first hydrophobic layer 13 and the second hydrophobic layer 21 and the size of the individual electrodes 24 between picoliters and microliters by adjusting the distance between the first hydrophobic layer 13 and the second hydrophobic layer 21 and the size of the individual electrodes 24.

Specifically, referring to FIG. 4, an electrode array comprised of electrodes 24 operates the large droplets to move in the direction of the arrow in the figure by controlling the electrode array to separate a large micro-droplet 201 from a large droplet while the large droplet continues to move in the direction of the arrow while the micro-droplet 201 remains in place.

Further shown in FIG. 5, by repeating the operation shown in FIG. 4, the large droplets may leave a plurality of micro-droplets 201 on their path of travel, several electrodes 24 are spaced between the micro-droplets 201 to avoid the combination of the micro-droplets 201, the electrodes 24 under the micro-droplets 201 are actuated to fix the micro-droplets 201 in situ, and after the target micro-droplets 201 are separated, the separation step is stopped or repeated until the large droplets are depleted completely.

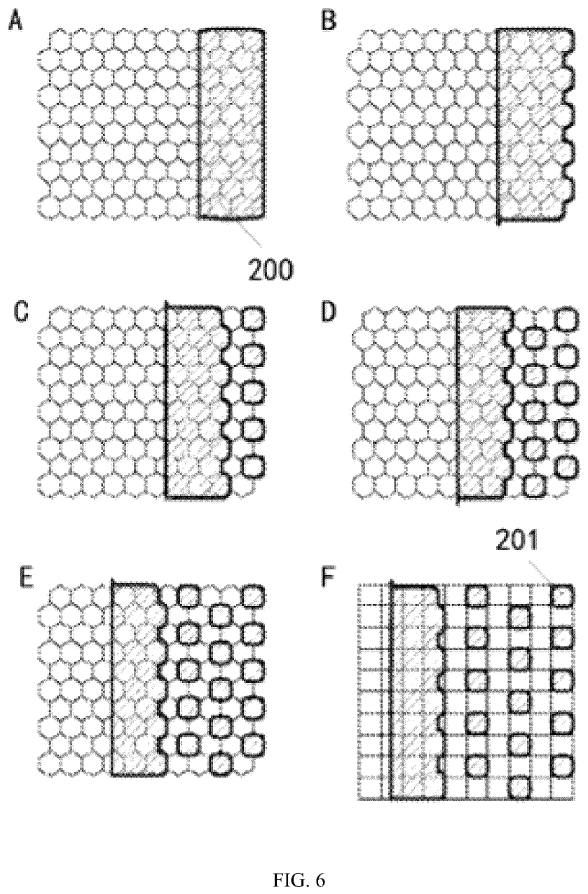

Further shown in FIG. 6, steering the large droplets in the order of FIG. 6 (A) through 6 (F), so that it leaves a plurality of micro-droplets 201 on the path, electrodes 24 are spaced apart between the micro-droplets 201 to avoid bonding of the micro-droplets 201, the lower electrode 24 of the micro-droplet 201 is actuated to fix the micro-droplet 201 in situ. The separation step is stopped or repeated until the large droplets are completely depleted after the target micro-droplets 201 can be separated, and the volume of the micro-droplets 201 between the first hydrophobic layer 13 and the second hydrophobic layer 21 can be precisely controlled between picoliter and microliter by adjusting the distance h of the fluid channel layer 101 and the size of the electrode 24.

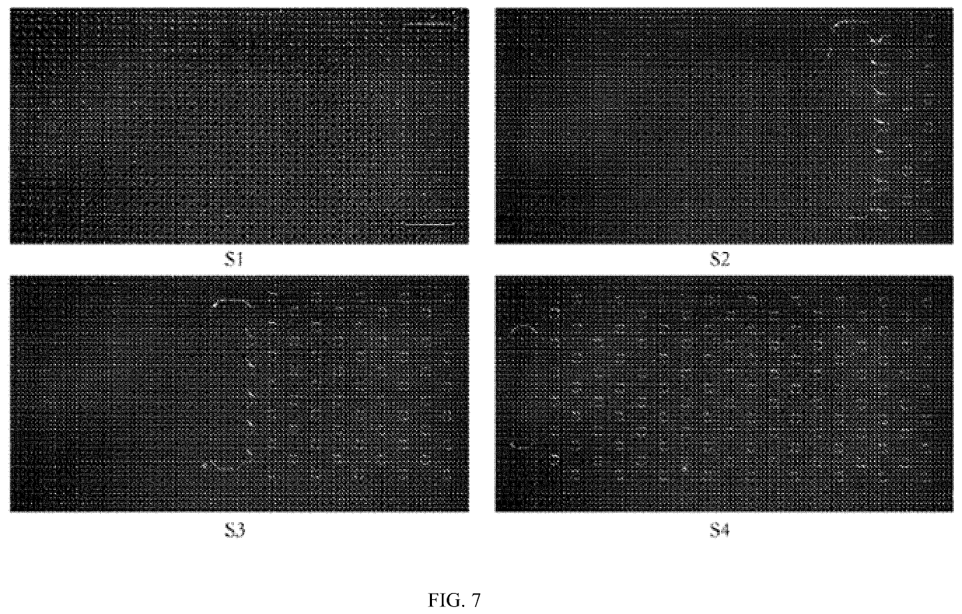

FIG. 7 illustrates an actual experimental procedure of moving a large droplet of Embodiment 1 of the present invention on a microfluidic chip to form a plurality of micro-droplets, the process of moving a large droplet on a microfluidic chip to form a plurality of micro-droplets being consistent with FIG. 6.

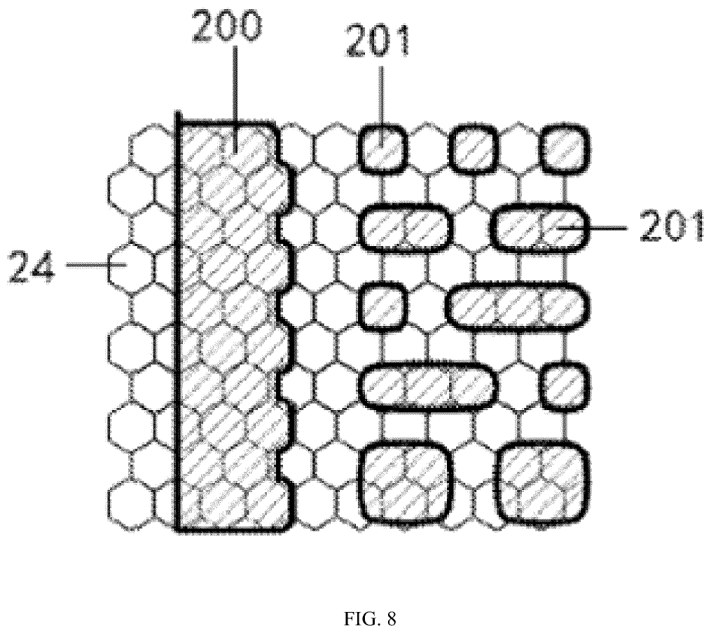

Referring to FIG. 8, micro-droplets 201 of different sizes may be formed on the electrode layer 23 when the electrodes 24 are of different sizes, or when one or more adjacent electrodes 24 are simultaneously actuated.

The invention also provides a micro-droplet generation method using the micro-droplet generation system shown in FIG. 2, which comprises the following steps:

The opening or closing of the electrode 24 of the electrode layer 23 is controlled so that when large droplets flow through the electrode layer 23, micro-droplets 201 are formed at the hydrophilic point array of the electrode layer 23.

In one embodiment, the volume of micro-droplet 201 is controlled by controlling the size of hydrophilic point 131.

The above-mentioned micro-droplet generating method, by adding large droplets to the fluid channel layer 101, the electrode driving unit is used for driving large liquid drops to flow in the fluid channel layer 101, and when the large liquid drops pass through the hydrophilic point 131, liquid micro-droplets 201 are left at the hydrophilic point 131 due to the hydrophilic effect of the hydrophilic point 131, so that the liquid drop generating time can be greatly shortened; and in addition, the liquid micro-droplet generating system does not need to separate the liquid micro-droplets 201 through the control electrode 24, so that the operation is simpler and more convenient.

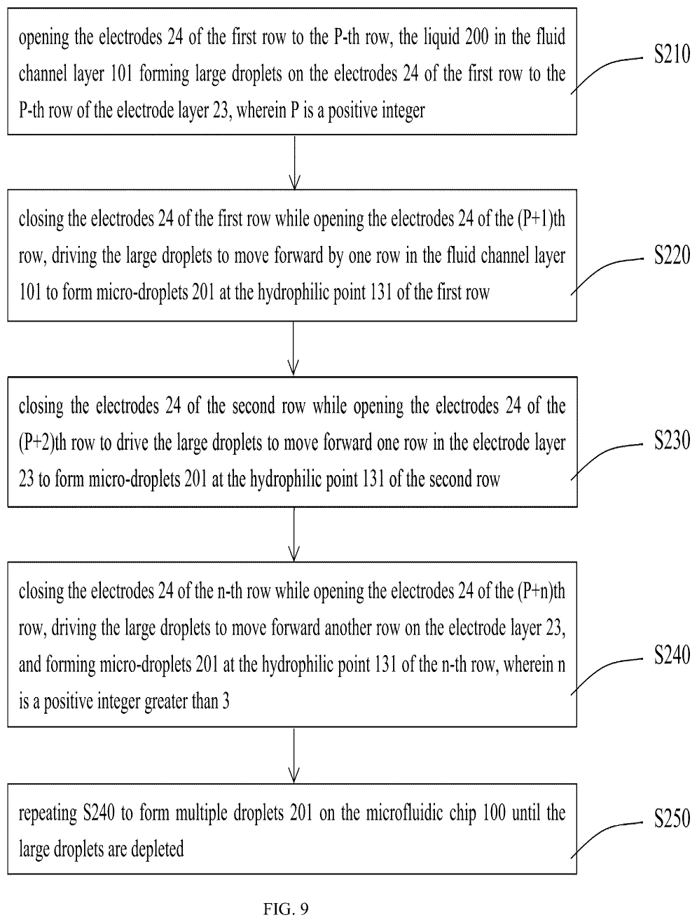

Referring to FIG. 9, the operation of forming micro-droplets 201 at the hydrophilic point array of the electrode layer 23 as large droplets flow through electrode layer 23 by controlling the opening or closing of electrode 24 of the electrode layer 23 is as follows:
S210, opening the electrodes 24 of the first row to the P-th row, the liquid 200 in the fluid channel layer 101 forming large droplets on the electrodes 24 of the first row to the P-th row of the electrode layer 23, wherein P is a positive integer;
S220, closing the electrodes 24 of the first row while opening the electrodes 24 of the (P+1)th row, driving the large droplets to move forward by one row in the fluid channel layer 101 to form micro-droplets 201 at the hydrophilic point 131 of the first row;
S230, closing the electrodes 24 of the second row while opening the electrodes 24 of the (P+2)th row, driving the large droplets to move one row further forward on the electrode layer 23, and forming micro-droplets 201 at the hydrophilic point 131 of the second row;
S240, closing the electrodes 24 of the n-th row while opening the electrodes 24 of the (P+n)th row, driving the large droplets to move forward another row on the electrode layer 23, and forming micro-droplets 201 at the hydrophilic point 131 of the n-th row, wherein n is a positive integer greater than 3;
S250, repeating S240 to form a plurality of micro-droplets 201 on the microfluidic chip 100 until the large droplets are depleted.

It will be appreciated that the specific operations of repeating S240 in S250 are: n is 3, and S140 is performed once; n is 4, executing S140 once; n is 5, and S140 is performed once, and so on, until the large droplet is depleted. That is, large droplets move sequentially from the first row to the n th row, and a plurality of micro-droplets 201 are formed in each of the first row to the n th row.

It will be appreciated that the “row” in the micro-droplet generation method described above may be designated by a “column”, i.e., large droplets move sequentially from the first column to the n th column, and a plurality of micro-droplets 201 are formed in each of the first column to the n th column.

In the above micro-droplet generation method, the target number of droplets can be separated by repeating the separation steps.

The micro-droplet generating method is different from the conventional digital microfluidic method for generating micro-droplets 201 The conventional digital microfluidic method comprises controlling a large droplet to generate a micro-droplet 201, then transporting the micro-droplet 201 to a corresponding position, controlling liquid 200 passes through fluid channel layer 101. By manipulating the electrode 24 so that the large droplets leave micro-droplets 201 on the path through which they pass. Or perform an array of hydrophilic modifications to the upper plate 11, when large droplets pass through the hydrophilic point 131, micro-droplets 201 can be left at the hydrophilic point 131 due to the hydrophilic effect of the hydrophilic point 131. Compared with the conventional method for generating the micro-droplets 201 through digital microfluidic control, the micro-droplet generating method can greatly shorten the droplet generating time.

In the above-mentioned micro-droplet generating method, by driving large droplets on the electrode layer 23 using coating-like manipulation, by controlling the electrodes 24 or by array-type hydrophilic modification of the upper plate 11, high throughput nanoliter-level droplet generation can be achieved. The volume of the droplet can be precisely adjusted by adjusting the size of the electrode 24, the gap distance between the electrodes 24, or precisely adjusting the size of the hydrophilic modification point. When the high-throughput nanoliter droplet separation is completed, corresponding experiments and detection can be carried out on the digital microfluidic chip. And the method can be matched with an optical detection module to realize biochemical application functions such as ddPCR, dLAMP, dELISA single cell experiment and the like, and is suitable for other nucleic acid detection such as isothermal amplification. Screening or independent experiment can be carried out on any micro-droplets of the microfluidic chip 100, and more micro-droplets can be separated or multiple groups of samples can be separated by expanding the size of the microfluidic chip 100.

### Embodiment 2

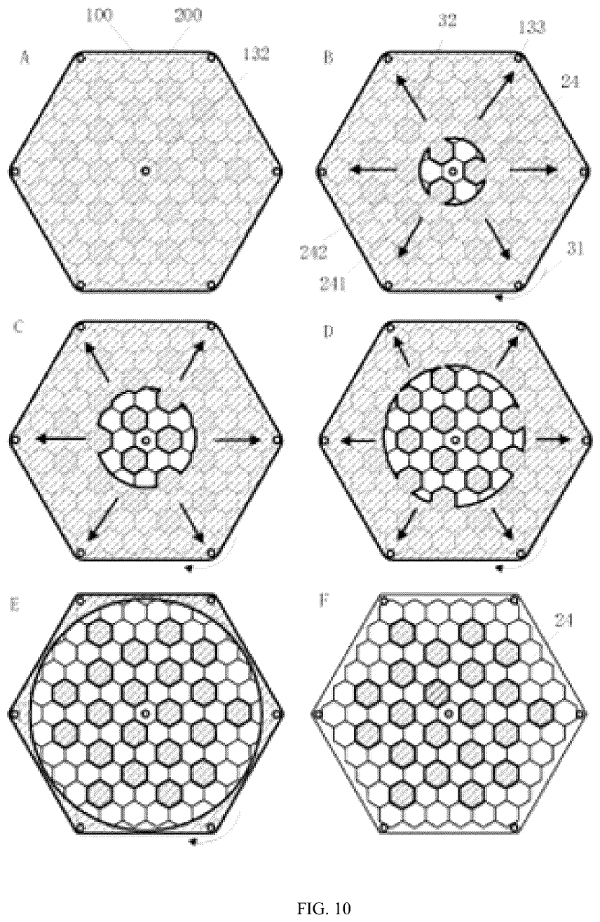

As shown in FIGS. 10-13, the particular structure of the micro-droplet generation system and micro-droplet generation method according to Embodiment 2 of the present application are specifically illustrated that Embodiment 2 is a variant of Embodiment 1.

The micro-droplet generation system of Embodiment 2 includes a microfluidic chip 100 and a droplet driving unit connected to the microfluidic chip 100. The microfluidic chip 100 includes an upper electrode plate 10 and a lower electrode plate 20. The upper electrode plate 10 comprises an upper plate 11, a conductive layer 12 and a first hydrophobic layer 13 which are sequentially arranged. The lower electrode plate 20 comprises a second hydrophobic layer 21, a dielectric layer 22 and an electrode layer 23 which are sequentially arranged. The first hydrophobic layer 13 and the second hydrophobic layer 21 are oppositely arranged, the fluid channel layer 101 is formed between the first hydrophobic layer 13 and the second hydrophobic layer 21. The electrode layer 23 comprises a plurality of electrodes 24 arranged in an array, at least one of the upper electrode plate 10 and the lower electrode plate 20 forms a plurality of suction points, and the suction points are used for adsorbing liquid 200. The droplet driving unit is used for driving the liquid 200 injected into the fluid channel layer 101 to flow in the fluid channel layer 101 so as to form micro-droplets 201 at the position of the suction point.

Unlike Embodiment 2, as shown in FIG. 10, a liquid injection hole 132 is formed in the center of the microfluidic chip 100. The injection hole 132 is adapted to inject a liquid 200 into the fluid channel layer 101. The microfluidic chip 100 is also provided with a plurality of drain holes 133. The liquid drain hole 133 is used for discharging excess liquid 200 from the microfluidic chip 100, the droplet driving unit is a rotary driving unit, and the rotary driving unit is used for driving the microfluidic chip 100 to rotate, so that the liquid 200 injected into the fluid channel layer 101 forms micro-droplets 201 at the suction point in a spin-coating mode.

It will be appreciated that wherein the liquid injection hole 132 is formed in the center of the microfluidic chip 100. In order to enable the liquid 200 to be uniformly injected into the fluid channel layer 101 to uniformly form micro-droplets 201 on the microfluidic chip 100 when the microfluidic chip 100 is rotated, in some embodiments of the present application, the injection hole 132 may also not be in the center of the microfluidic chip 100, and the present application does not limit this.

Notably, the rotary driving unit can be equipment such as a turntable and turntable and can enable the microfluidic chip 100 to rotate. The specific structure of the rotary driving unit is not limited.

Specifically, in the order shown in FIGS. 10 (A) through 10 (F), first, as shown in FIG. 10 (A), a microfluidic chip 100 comprised of electrodes 24 is first filled with liquid 200 via a liquid injection hole 132, then, the microfluidic chip 100 begins to rotate in the direction shown by a first arrow 31 in FIG. 10 (B) and generates centrifugal force such that the liquid 200 moves in the direction shown by a second arrow 32 in FIG. 10 (B) along the microfluidic chip 100. By controlling the opening of a portion of the electrodes 24 on the microfluidic chip 100, as shown in FIG. 10 (B), an unactuated electrode 242 is spaced between adjacent actuated electrodes 241, this allows the liquid 200 to leave a set of micro-droplets 201. As shown in FIGS. 10 (C)-10 (F), the microfluidic chip 100 rotates continuously, liquid 200 continues to evacuate in the direction of the arrows from drain holes 133 located at four corners of the array, while micro-droplets 201 remain in the position of actuated electrodes 241. To continuously rotate microfluidic chip 100 to maintain centrifugal force, the electrodes 24 under the micro-droplets 201 can be actuated to fix the micro-droplets 201 in situ, and the target micro-droplets 201 can be separated and centrifuged continuously until the excess liquid 200 is drained completely.

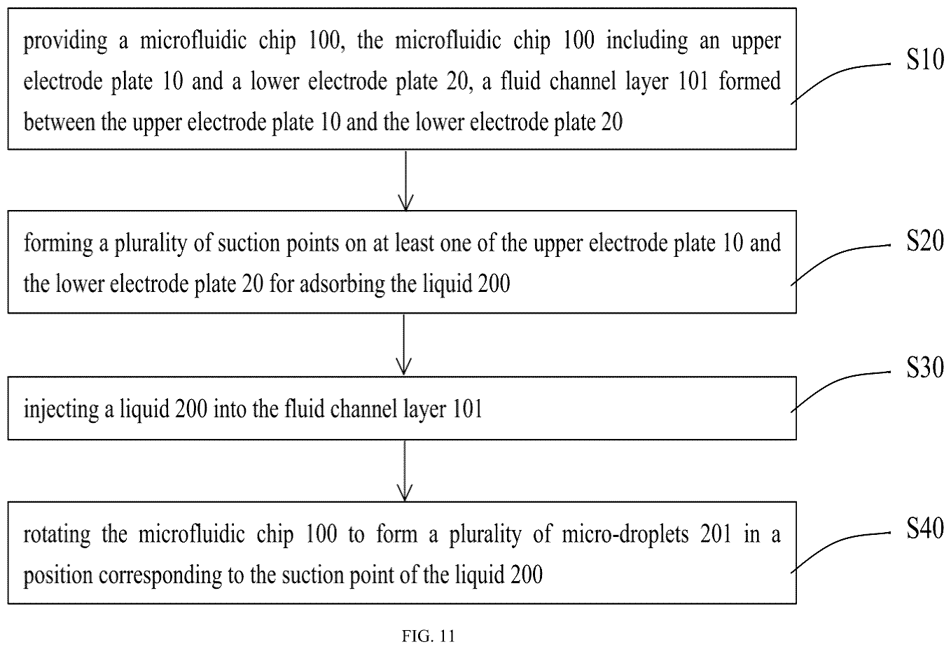

It will be appreciated that, as shown in FIG. 11, in Embodiment 2, the micro-droplet generation method comprises the steps of:
S10, providing a microfluidic chip 100, the microfluidic chip 100 including an upper electrode plate 10 and a lower electrode plate 20, a fluid channel layer 101 formed between the upper electrode plate 10 and the lower electrode plate 20;
S20, forming a plurality of suction points on at least one of the upper electrode plate and the lower electrode plate 20 for adsorbing the liquid 200;
S30, injecting a liquid 200 into the fluid channel layer 101;
S40, rotating the microfluidic chip 100 to form a plurality of micro-droplets 201 in a position corresponding to the suction point of the liquid 200.

It will be appreciated that the sequence of S20 and S30 is not limited to S20 followed by S30. In particular cases, S30 may be followed by S20.

The above-mentioned micro-droplet generating method, by adding the liquid 200 to the fluid channel layer 101, and rotating the microfluidic chip 100, whereby the liquid 200 can be caused to flow through the fluid channel layer 101 by centrifugal force, as the liquid 200 passes through the suction point, due to the suction action of the suction point, the micro-droplet generating method described above leaves micro-droplets 201 in the fluid channel layer 101 at positions corresponding to the suction points. A large number of micro-droplets 201 can be rapidly prepared, the droplet generation time is greatly shortened, the operation process is simple and convenient, high-precision micropumps and other equipment are not needed, the system cost is reduced, the expansion capability is strong, and more micro-droplets or multiple groups of samples can be separated by expanding the size of the microfluidic chip 100.

Specifically, the suction point can be formed by different methods, as described in detail below with respect to the method for generating micro-droplets.

In an embodiment 2 of the present application, the suction point is formed by actuated electrodes 241 actuated by the electrode layer 23, and adjacent actuated electrodes 241 are spaced apart by unactuated electrodes 242.

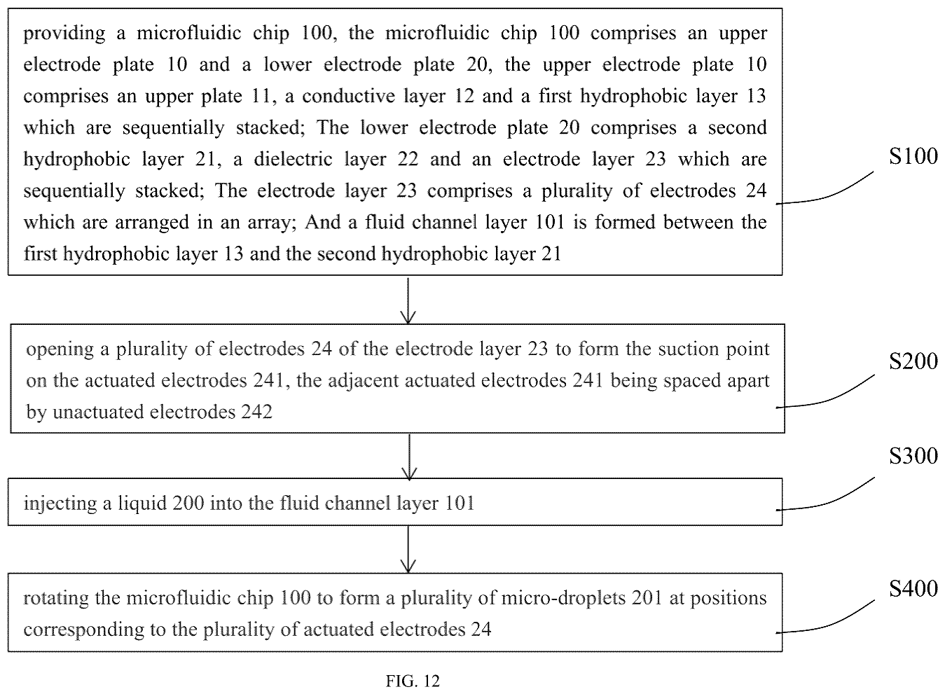

Accordingly, referring to FIG. 12, the micro-droplet generation method includes the steps of:
S100, providing a microfluidic chip 100, the microfluidic chip 100 comprises an upper electrode plate 10 and a lower electrode plate 20, the upper electrode plate 10 comprises an upper plate 11, a conductive layer 12 and a first hydrophobic layer 13 which are sequentially stacked; The lower electrode plate 20 comprises a second hydrophobic layer 21, a dielectric layer 22 and an electrode layer 23 which are sequentially stacked; The electrode layer 23 comprises a plurality of electrodes 24 which are arranged in an array; And a fluid channel layer 101 is formed between the first hydrophobic layer 13 and the second hydrophobic layer 21;
S200, opening a plurality of electrodes 24 of the electrode layer 23 to form the suction point on the actuated electrodes 241, the adjacent actuated electrodes 241 being spaced apart by unactuated electrodes 242;
S300, injecting a liquid 200 into the fluid channel layer 101;
S400, rotating the microfluidic chip 100 to form a plurality of micro-droplets 201 at positions corresponding to the plurality of actuated electrodes 24.

It will be appreciated that S200 and S300 are not limited in order and that S200 may be performed first and then S300 or S200 may be performed first and then S300.

The above-mentioned micro-droplet generating method, by adding the liquid 200 to the fluid channel layer 101, and rotating the microfluidic chip 100, thus, the liquid 200 can be centrifugally formed into a plurality of micro-droplets 201 at positions corresponding to the plurality of actuated electrodes 24 in the fluid channel layer 101. A large number of micro-droplets 201 can be rapidly prepared, the droplet generation time is greatly shortened, the operation process is simple and convenient, high-precision micropumps and other equipment are not needed, the system cost is reduced, the expansion capability is strong, and more micro-droplets or multiple groups of samples can be separated by expanding the size of the microfluidic chip 100.

It will be understood that, in the preparation of micro-droplets 201, the electrodes 24 of the electrode layer 23 are not fully turned on, comprising an actuated electrode 241 and an unactuated electrode 242 in order to prevent the micro-droplets 201 from bonding to each other. It will be appreciated that adjacent actuated electrodes 241 are spaced apart by unactuated electrodes 242, that adjacent actuated electrodes 241 are spaced apart from each other by at least one unactuated electrode 242 preferably, and that adjacent actuated electrodes 241 are spaced apart by two unactuated electrodes 242.

Notably, in the step of injecting the liquid 200 into the fluid channel layer 101, injecting a liquid 200 into the center of the fluid channel layer 101 with reference to FIG. 9 (A). That is, a liquid injection hole 132 may be formed in the center of the microfluidic chip 100. It will be appreciated that the addition of the liquid 200 from the injection hole 132 to the fluid channel layer 101, liquid 200 may also be added to other locations on the microfluidic chip 100; The whole fluid channel layer 101 is fully distributed, and excess liquid 200 is drained by rotating the microfluidic chip 100. Of course, the liquid 200 is injected from the center of the microfluidic chip 100, and the liquid 200 can be dispersed from the center to the periphery through the rotation of the microfluidic chip 100, so that small-volume liquid 200 is formed on the actuated electrode 241, and the amount of the liquid 200 can be effectively reduced.

It should be noted that in step S400, when the excess liquid 200 flows out of the fluid channel layer 101, the rotation of the microfluidic chip 100 is stopped. Referring specifically to FIG. 9 (B), the four corners of the microfluidic chip 100 are provided with drain holes 133 through which the excess liquid 200 is drained out of the fluid channel layer 101.

In this embodiment of the present application, the microfluidic chip 100 rotates at a speed greater than 0 rpm and less than or equal to 1000 rpm.

In this embodiment of the present application, the distance h between the first hydrophobic layer 13 and the second hydrophobic layer 21 is 5 μm to 600 μm.

In this embodiment of the present application, the electrode 24 is a regular hexagon, and the side length of the electrode 24 is 50 μm to 2 mm, it will be appreciated that the shape of the electrode 24 can be any shape or combination of any shapes, And the volume of the micro-droplet 201 can be precisely adjusted by adjusting the size of the electrode 24, the gap distance of the electrode 24, and the like.

In this embodiment of the present application, the upper plate 11 may be made of a glass substrate having a thickness of 0.05 mm to 1.7 mm.

In this embodiment of the present application, the conductive layer 12 may be made of an ITO conductive layer having a thickness of 10 nm to 500 nm.

In this embodiment of the present application, the material of the first hydrophobic layer 13 can be a fluorine-containing hydrophobic coating, and the thickness of the first hydrophobic layer 13 is 10 nm to 200 nm.

In this embodiment of the present application, the material of the second hydrophobic layer 21 may be a fluorine-containing hydrophobic coating, and the thickness of the second hydrophobic layer 21 is 10 nm to 200 nm.

In this embodiment of the present application, the dielectric layer 22 may be made of an organic insulating layer or an inorganic insulating layer having a thickness of 50 nm to 1000 nm.

In this embodiment of the present application, the electrode layer 23 may be made of transparent conductive glass or a metal electrode layer 23 having a thickness of 10 nm to 1000 nm.

In the embodiment 2 of the application, the suction points can also be formed by hydrophilic points 131, specifically, the upper electrode plate 10 is provided with a hydrophilic point array on one side of the first hydrophobic layer 13 far away from the conductive layer 12, the hydrophilic points 131 of the hydrophilic point array are the suction points, and the adjacent hydrophilic points 131 are arranged at intervals.

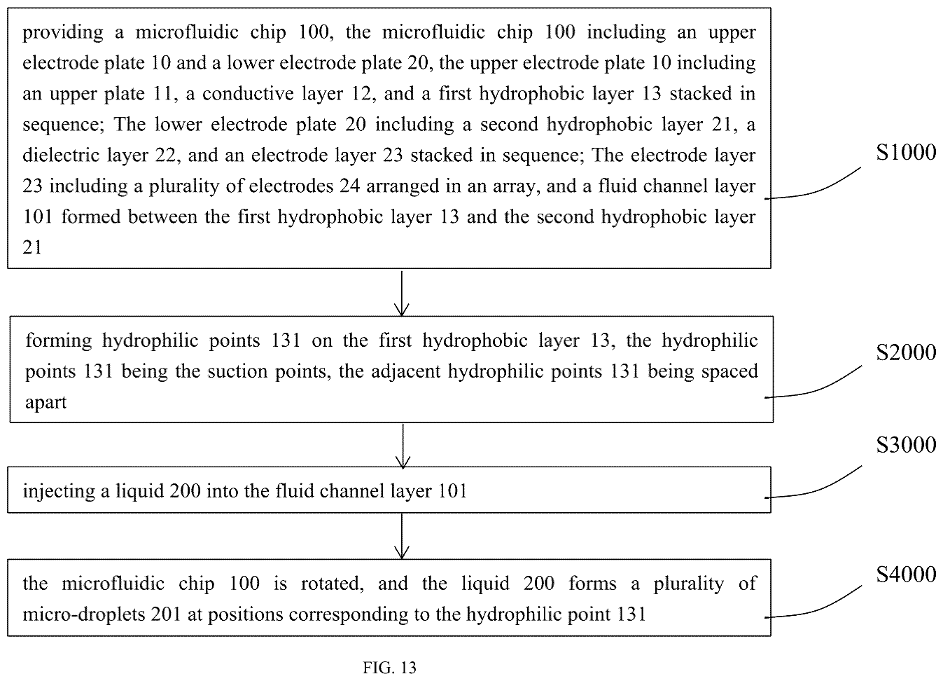

Correspondingly, as shown in FIG. 13, the micro-droplet generation method comprises the steps of:
S1000, providing a microfluidic chip 100, the microfluidic chip 100 including an upper electrode plate 10 and a lower electrode plate 20, the upper electrode plate 10 including an upper plate 11, a conductive layer 12, and a first hydrophobic layer 13 stacked in sequence; The lower electrode plate 20 including a second hydrophobic layer 21, a dielectric layer 22, and an electrode layer 23 stacked in sequence; The electrode layer 23 including a plurality of electrodes 24 arranged in an array, and a fluid channel layer 101 formed between the first hydrophobic layer 13 and the second hydrophobic layer 21;
S2000, forming hydrophilic points 131 on the first hydrophobic layer 13, the hydrophilic points 131 being the suction points, the adjacent hydrophilic points 131 being spaced apart;
S3000, injecting a liquid 200 into the fluid channel layer 101;
S4000, the microfluidic chip 100 is rotated, and the liquid 200 forms a plurality of micro-droplets 201 at positions corresponding to the hydrophilic point 131.

The above-mentioned micro-droplet generating method, by adding the liquid 200 to the fluid channel layer 101, and rotating the microfluidic chip 100, whereby the liquid 200 can be caused to flow through the fluid channel layer 101 by centrifugal force, as large droplets pass through the hydrophilic point 131, due to the hydrophilic action of the hydrophilic point 131, a method for generating micro-droplets 201 is disclosed in which micro-droplets 201 are left in a fluid channel layer 101 at positions corresponding to a hydrophilic point 131 can rapidly prepare a large number of micro-droplets 201. The droplet generation time is greatly shortened, the operation process is simple and convenient, the micro-droplet 201 can be separated without controlling the electrode 24 so that the operation is simpler and more convenient without high-precision micropumps and other equipment, the system cost is reduced, the expansion capability is strong, and more micro-droplets or multiple groups of samples can be separated by expanding the size of the microfluidic chip 100.

It will be appreciated that, in the step of injecting the liquid 200 into the fluid channel layer 101, injecting liquid 200 into the center of the fluid channel layer 101. A liquid injection hole 132 may be formed in the center of the microfluidic chip 100. It will be appreciated that the addition of the liquid 200 from the injection hole 132 to the fluid channel layer 101, liquid 200 may also be added to other locations on the microfluidic chip 100. The whole fluid channel layer 101 is fully distributed, and excess liquid 200 is drained by rotating the microfluidic chip 100. Of course, the liquid 200 is injected from the center of the microfluidic chip 100, and the liquid 200 can be dispersed from the center to the periphery through the rotation of the microfluidic chip 100, so that small-volume liquid 200 is formed on the actuated electrode 241, and the amount of the liquid 200 can be effectively reduced.

In this embodiment of the present application, in step S4000, when the excess liquid 200 flows out of the fluid channel layer 101, the rotation of the microfluidic chip 100 is stopped. Specifically, the four corners of the microfluidic chip 100 are provided with drain holes 133 through which the excess liquid 200 is drained out of the fluid channel layer 101.

In this embodiment of the present application, the microfluidic chip 100 is rotated at a rotational speed greater than 0 rpm and less than or equal to 1000 rpm.

In this embodiment of the present application, the distance between the first hydrophobic layer 13 and the second hydrophobic layer 21 is 5 μm to 600 μm, i.e., the distance h of the fluid channel layer 101 is 5 μm to 600 μm.

In this embodiment of the present application, the hydrophilic point 131 is prepared by treating the hydrophobic coating at the desired location of the first hydrophobic layer 13 with laser or plasma to obtain the hydrophilic point 131.

In this embodiment of the present application, a plurality of hydrophilic points 131 on the first hydrophobic layer 13 are arranged in an array.

It will be appreciated that, in Embodiment 2, the micro-droplet generating system performs a spin-coating-like operation on the surface of the electrode array by a centrifugal force rotationally applied by the rotary driving unit, by controlling the electrode 24 or carrying out array-type hydrophilic modification on the upper plate 11. The arrayed hydrophilic modification enables the high-throughput generation of nanoliter-level droplets. The volume of droplets can be precisely adjusted by adjusting the size of the electrode 24, the gap distance, the size of a hydrophilic modification point and the like.

### Embodiment 3

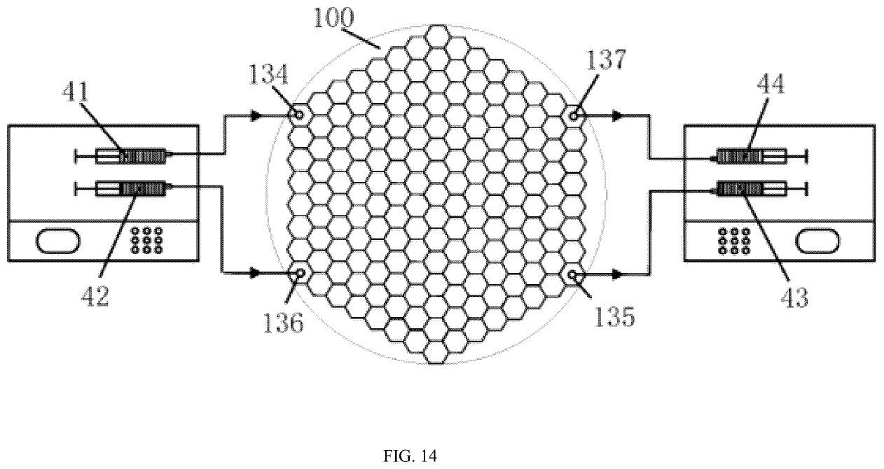

As shown in FIGS. 14-21, the specific configuration of the micro-droplet generation system and micro-droplet generation method according to Embodiment 3 of the present application is specifically illustrated in Embodiment 3 as another variant of Embodiment 1.

The micro-droplet generation system of Embodiment 3 includes a microfluidic chip 100 and a droplet driving unit connected to the microfluidic chip 100. The microfluidic chip 100 includes an upper electrode plate 10 and a lower electrode plate 20. The upper electrode plate 10 comprises an upper plate 11, a conductive layer 12 and a first hydrophobic layer 13 which are sequentially arranged. The lower electrode plate 20 comprises a second hydrophobic layer 21, a dielectric layer 22 and an electrode layer 23 which are sequentially arranged, the first hydrophobic layer 13 and the second hydrophobic layer 21 are oppositely arranged, the fluid channel layer 101 is formed between the first hydrophobic layer 13 and the second hydrophobic layer 21. the electrode layer 23 comprises a plurality of electrodes 24 arranged in an array, at least one of the upper electrode plate 10 and the lower electrode plate 20 forms a plurality of suction points, and the suction points are used for adsorbing liquid 200. The droplet driving unit is used for driving the liquid 200 injected into the fluid channel layer 101 to flow in the fluid channel layer 101 so as to form micro-droplets 201 at the position of the suction point.

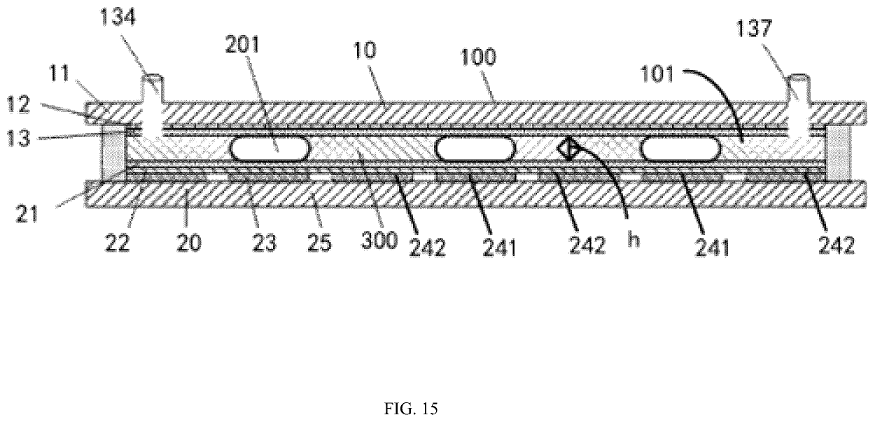

Specifically, as shown in FIGS. 14 and 15, unlike Embodiment 1, The microfluidic chip 100 is provided with a first sample injection hole 134 and a first sample drain hole 135, The first sample injection hole 134 and the first sample drain hole 135 are disposed on a first diagonal of the microfluidic chip 100. The liquid droplet driving unit comprises a first micropump 41 and a third micropump 43, wherein the first micropump 41 is connected with the first sample injection hole 134 and used for injecting liquid 200 into the fluid channel layer 101 so as to enable the fluid channel layer 101 to be filled with the liquid 200, and the third micropump 43 is connected with the first sample drain hole 135 and used for pumping the liquid 200 flowing out of the first sample drain hole 135.

It should be noted that the diagonal position of the first injection hole 134 and the first sample drain hole 135 is selected to ensure that the liquid 200 can fill the entire fluid channel layer 101 without bubbles.

Further, the microfluidic chip 100 is further provided with a second sample injection hole 136 and a second sample drain hole 137. The second sample injection hole 136 and the second sample drain hole 137 are disposed on a second diagonal of the microfluidic chip 100. The droplet drive unit further includes a second micropump 42 and a fourth micropump 44. The second micropump 42 is connected to the second sample injection hole 136, for injecting a medium 300 into said fluid channel layer 101, said liquid 200 at a non-suction point being pushed out by said medium 300 when a second micropump 42 injects a medium into said fluid channel layer 101, said liquid 200 leaving a micro-droplet 201 at a location corresponding to said suction point, said medium 300 wrapping said micro-droplet. The fourth micropump 44 is connected to the second sample drain hole 137 for extracting the medium 300 flowing out of the second sample drain hole 137.

It should be noted that the reason for the second injection hole 136 and the second sample drain hole 137 to select diagonal positions is to ensure that the medium 300 may be air or oil or the like to sufficiently drain the liquid 200 at the non-suction point position throughout the fluid channel layer 101.

It should also be noted that the first micropump 41, the second micropump 42, the third micropump 43, and the fourth micropump 44 are, but are not limited to, digital syringe pumps, and pumps that enable stable inflow and outflow of the liquid 200 can be implemented.

In this embodiment of the present application, the upper plate 11 may be made of a glass substrate, and the thickness of the upper plate 11 may range from 0.05 mm to 1.7 mm.

In this embodiment of the present application, the material of the conductive layer 12 may be an ITO conductive layer, and the thickness of the conductive layer 12 may range from 10 nm to 1000 nm.

In this embodiment of the present application, the thickness of the first hydrophobic layer 13 may range from 10 nm to 200 nm.

In this embodiment of the present application, the thickness of the second hydrophobic layer 21 may range from 10 nm to 200 nm.

In this embodiment of the present application, the material of the dielectric layer 22 may be an organic or inorganic insulating material, and the thickness of the dielectric layer 22 may range from 50 nm to 1000 nm.

In this embodiment of the present application, the material of the electrode layer 23 may be metal and its oxide conductive material, and the thickness of the electrode layer 23 may range from 10 nm to 500 nm.

In this embodiment of the present application, the lower electrode plate 20 may further include a substrate 25 disposed on one side of the electrode layer 23 remote from the dielectric layer 22 for protecting the lower electrode plate 20. In one embodiment, the substrate 25 may be made of glass or a PCB substrate. The thickness of the substrate 25 may range from 0.05 mm to 5 mm.

It will be appreciated that suction points may be formed on the upper electrode plate 10, may be formed on the lower electrode plate 20, or may be simultaneously formed on the upper electrode plate 10 and the lower electrode plate Multiple suction points on the upper electrode plate 10 or the lower electrode plate are arranged in an array.

Specifically, the suction point may be formed by different methods and may be formed by actuated electrodes 241 actuated by the electrode layer 23, with adjacent actuated electrodes 241 being spaced apart by unactuated electrodes 242.

The suction point may also be formed by a hydrophilic point 131, specifically, the upper electrode plate 10 is formed with an array of hydrophilic points on the side of the first hydrophobic layer 13 remote from the conductive layer 12. The hydrophilic points 131 of the hydrophilic point array are the suction points, and the adjacent hydrophilic points 131 are arranged at intervals. More specifically, the first hydrophobic layer 13 is subjected to hydrophilic modification, such as photoetching, etching and other micro-nano processing technologies, and the hydrophobic coating at the required position is treated on the first hydrophobic layer 13 to obtain the hydrophilic point array.

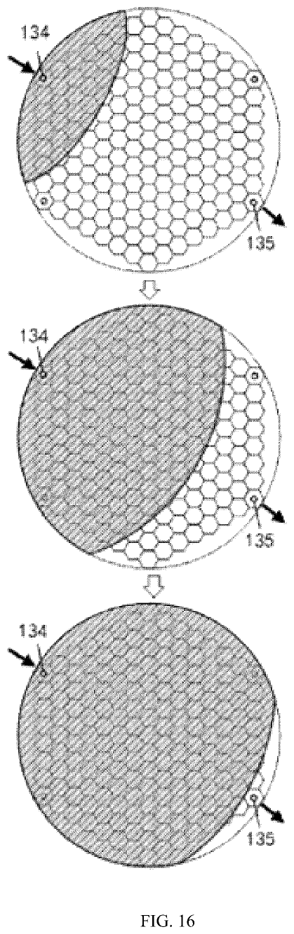

FIG. 16 illustrates the process of injecting a liquid into the micro-droplet generation system: By adjusting the first micropump 41, the liquid 200 flows in from the first sample injection hole 134, meanwhile, the third micropump 43 is used for extracting redundant gas to be filled with the liquid 200 in the microfluidic chip 100, the excess liquid is drained from the first sample drain hole 135, the pressure in the microfluidic chip 100 is kept horizontal in the whole process, so that the liquid 200 is filled in the whole fluid channel layer 101, and the liquid injection is finished.

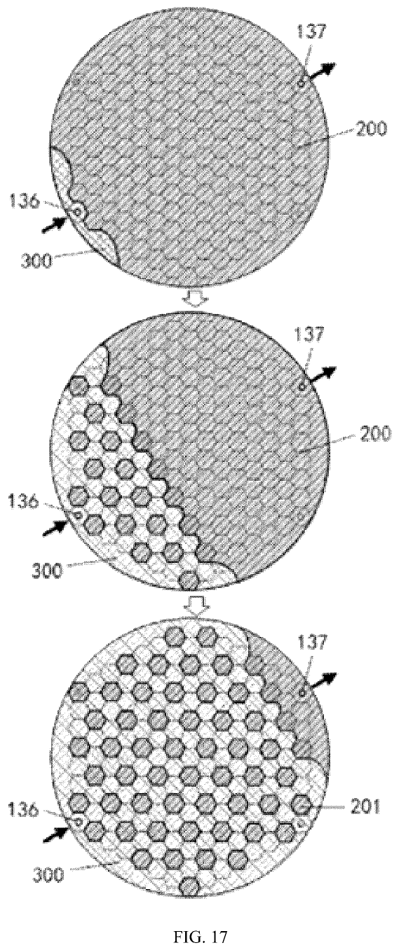

FIG. 17 illustrates a layout process of the micro-droplet generation system. That is, the process of forming large-density droplets: First, electrodes 24 in the microfluidic chip 100 which need to generate micro-droplets 201 are selectively energized to generate high-density micro-droplets 201 without cross infection. The micro-droplets 201 are typically selectively spaced apart by an electrode 24, i.e., the actuated electrodes 24 are separated by unactuated electrodes 24 by conditioning the second micropump 42. At this time, the medium 300 is injected into the microfluidic chip 100 from the second sample injection hole 136, and the fourth micropump 44 is used for pumping the liquid 200; when the liquid medium 200 is completely drained from the second sample drain hole 137, the excess medium 300 is drained from the second sample injection hole; after the sample arrangement is finished, micro-droplets 201 are left at the position of the electrode 24 which is selectively actuated in the microfluidic chip 100; and meanwhile, the micro-droplets 201 are wrapped in the target medium.

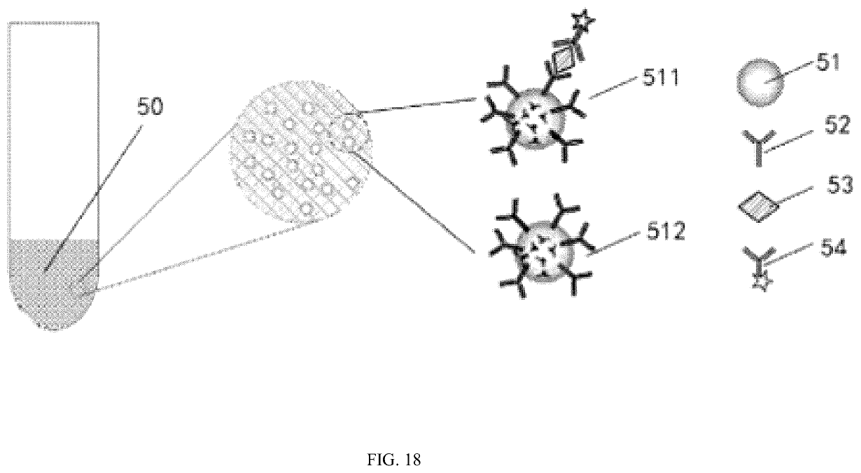

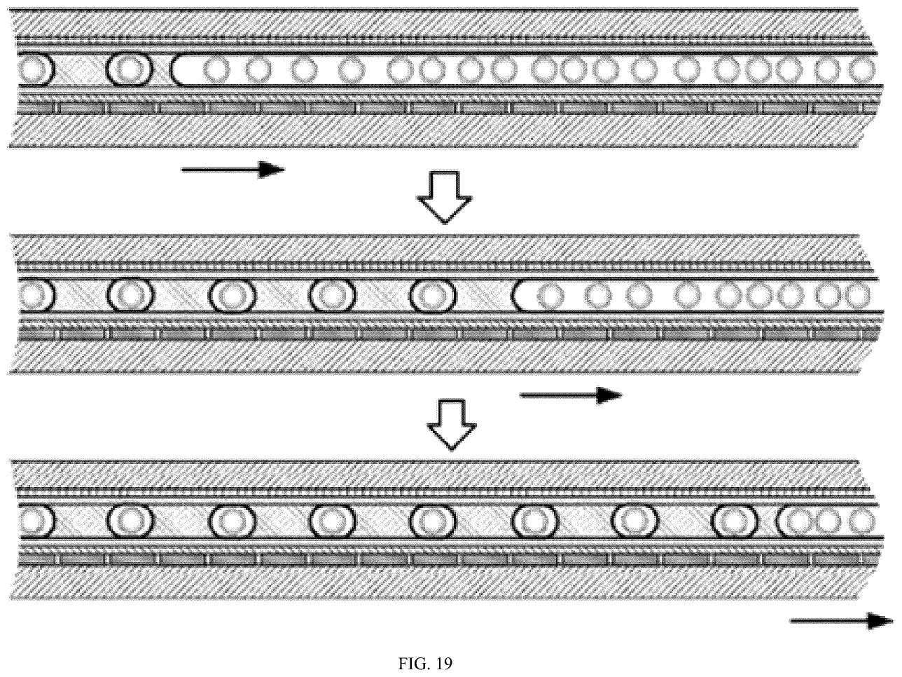

FIGS. 18 and 19 illustrate a flow diagram of the micro-droplet generation system implementing digital ELISA operation as shown in FIG. 18. The mixed solution 50 contains microbeads 51 (magnetic beads, PS beads et al.), capture antibody 52, target antigen 53, and fluorescently labelled antibody 54. After immunoreaction of the mixed solution 50, a first microbead 511 containing the target antigen and the fluorescently labelled antibody and a second microbead 512 containing no target antigen and the fluorescently labelled antibody are generated. Microbeads 51 are subsequently washed to remove any non-specifically bound proteins, and adding a substrate, finally, the mixed solution 50 adopts the above-mentioned micro-droplet generation method, injecting an electrowetting microarray microfluidic chip 100 in a pumping manner. A cross-sectional view of the electrowetting microfluidic chip 100 with respect to the formation of micro-droplets 201 forming a high-density micro-droplet array containing only one or more microbeads 51 per droplet is shown in FIG. 19. The microbeads 51 containing the target antigen 53 emit fluorescence due to the fluorescently labelled antibody 54, are digitally interpreted by a CCD imaging system, and the concentration of the target protein is calculated according to the Poisson distribution theory. The algorithm belongs to digital calculation rather than conventional ELISA analogue calculation, so that the algorithm is called digital ELISA (dELISA).

Additionally, the detection of multiple target antigens 53 can be accomplished if different fluorescently labelled antibodies 54 are labelled with fluorescent labels having different absorption and emission wavelengths.

The scheme adopts classical double-antibody sandwich enzyme-linked immunosorbent assay (ELISA). Said invention can implement quantitative detection of protein with very low content. The scheme is characterized by that it can implement single-molecule detection; By adopting analogue calculation, the detection sensitivity is far higher than that of the conventional method and is similar to the detection principle of the Quantix company, but the high-density array type micro-droplet forming mode is different from that of the Quantix company in that the micro-droplet generating method utilizes an electrowetting technology to form a high-density droplet array, and generated droplets can be randomly operated and controlled.

The micro-droplet generating system, liquid 200 is injected into the fluid channel layer 101 through a first micropump 41, filling the fluid channel layer 101 with liquid 200 which is attracted by an actuated electrode 24 to inject a medium 300 into the fluid channel layer 101 through a second micropump 42. The liquid 200 on the non-suction point is pushed by the medium 300 to be moved, the liquid 200 forms a plurality of micro-droplets 201 in the fluid channel layer 101 corresponding to the position of the actuated electrode 24, and the medium 300 wraps the micro-droplets 201. The micro-droplet generating method can rapidly prepare a large number of micro-droplets 201, greatly shortens the droplet generating time, and is simple and convenient in the operation process.

It will be appreciated that, the volume of the micro-droplets 201 can be precisely controlled between picoliters to microliters by adjusting the gap of the fluid channel layer 101 and the size of the electrode 24. The number of micro-droplets 201 can be controlled by adjusting the density of the electrodes 24 and the size of the entire microfluidic chip 100. After the separation of high-density nanoliter droplets is completed, the droplets can be precisely controlled on the digital microfluidic chip, and corresponding experiments and detections, such as ddPCR, dLAMP, dELISA single-cell experiments, and the like, can be performed.

When the high-density liquid micro-droplet completes the corresponding experiment, the system can also inject washing liquid into the fluid channel layer 101 through the micropump to quickly wash the microfluidic chip 100, or the microfluidic chip 100 can be repeatedly used. The medium 300 or the washing liquid can flow into the system from the sample injection hole by adjusting the digital micropump; meanwhile, waste liquid in the microfluidic chip 100 can be drained from the sample drain hole. The method is quick, convenient and easy to operate.

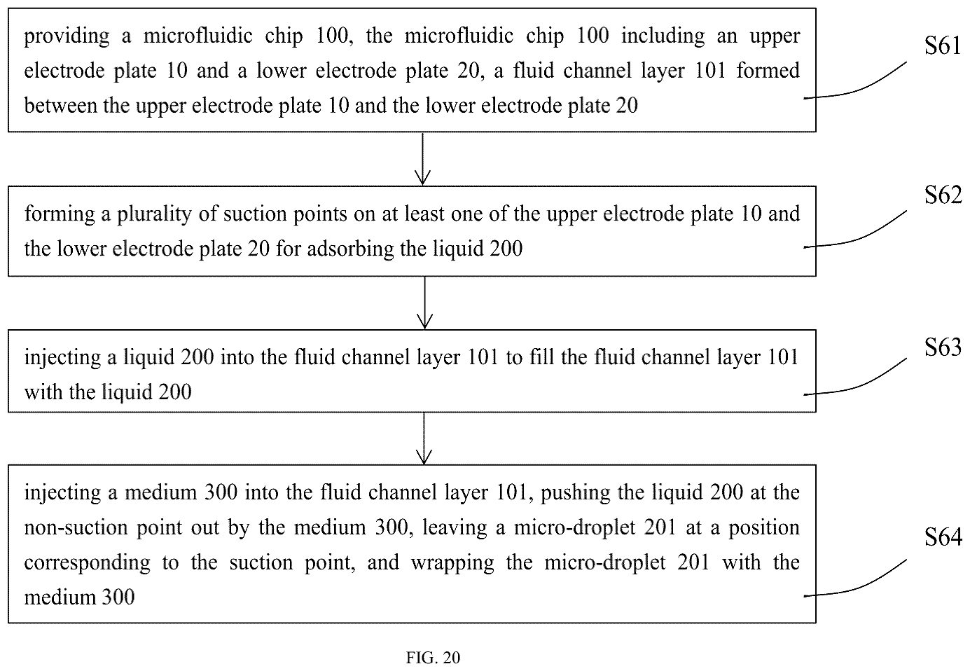

As shown in FIG. 20, in Embodiment 3, there is also provided a micro-droplet generation method comprising the steps of:
S61, providing a microfluidic chip 100, the microfluidic chip 100 including an upper electrode plate 10 and a lower electrode plate 20, a fluid channel layer 101 formed between the upper electrode plate 10 and the lower electrode plate
S62, forming a plurality of suction points on at least one of the upper electrode plate 10 and the lower electrode plate 20 for adsorbing the liquid 200;
S63, injecting a liquid 200 into the fluid channel layer 101 to fill the fluid channel layer 101 with the liquid 200;
S64, injecting a medium 300 into the fluid channel layer 101, pushing the liquid 200 at the non-suction point out by the medium 300, leaving a micro-droplet 201 at a position corresponding to the suction point, and wrapping the micro-droplet 201 with the medium 300.

It will be appreciated that the sequence of S62 and S63 is not limited to S62 followed by S63. In particular cases, S63 followed by S62 may also be performed.

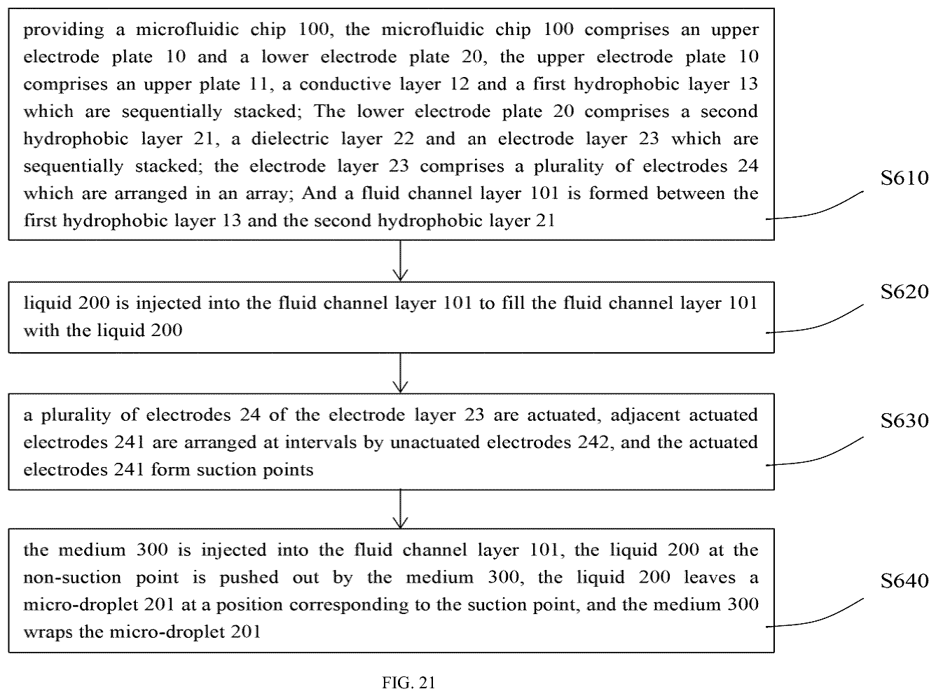

As shown in FIG. 21, the micro-droplet generation method specifically includes the steps of:
S610, providing a microfluidic chip 100, the microfluidic chip 100 comprises an upper electrode plate 10 and a lower electrode plate 20, the upper electrode plate 10 comprises an upper plate 11, a conductive layer 12 and a first hydrophobic layer 13 which are sequentially stacked; The lower electrode plate 20 comprises a second hydrophobic layer 21, a dielectric layer 22 and an electrode layer 23 which are sequentially stacked; the electrode layer 23 comprises a plurality of electrodes 24 which are arranged in an array; And a fluid channel layer 101 is formed between the first hydrophobic layer 13 and the second hydrophobic layer 21;
S620, liquid 200 is injected into the fluid channel layer 101 to fill the fluid channel layer 101 with the liquid 200;
S630, a plurality of electrodes 24 of the electrode layer 23 are actuated, adjacent actuated electrodes 241 are arranged at intervals by unactuated electrodes 242, and the actuated electrodes 241 form suction points;
S640, the medium 300 is injected into the fluid channel layer 101, the liquid 200 at the non-suction point is pushed out by the medium 300, the liquid 200 leaves a micro-droplet 201 at a position corresponding to the suction point, and the medium 300 wraps the micro-droplet 201.

It will be appreciated that S620 and S630 are not limited in order, and that S620 may be followed by S630, or S630 may be followed by S620.

It will be appreciated that, in the preparation of micro-droplets 201, the electrodes 24 of the electrode layer 23 are not fully turned on, comprising an actuated electrode 241 and an unactuated electrode 242 in order to prevent the micro-droplets 201 from bonding to each other. It will be appreciated that adjacent actuated electrodes 241 are spaced apart by unactuated electrodes 242, that adjacent actuated electrodes 241 are spaced apart from each other by at least one unactuated electrode 242 preferably, and that adjacent actuated electrodes 241 are spaced apart by two unactuated electrodes 242.

It will be appreciated that, in Embodiment 3, according to the invention, a sample is injected into the digital microfluidic chip through the digital injection pump according to a certain volume and a certain flow rate so as to realize control similar to coating; then the sample is drained by means of the digital injection pump, and the volume of the liquid droplet can be accurately regulated by means of regulating a number of control electrodes, size of electrodes and gap distance, etc.

### Embodiment 4

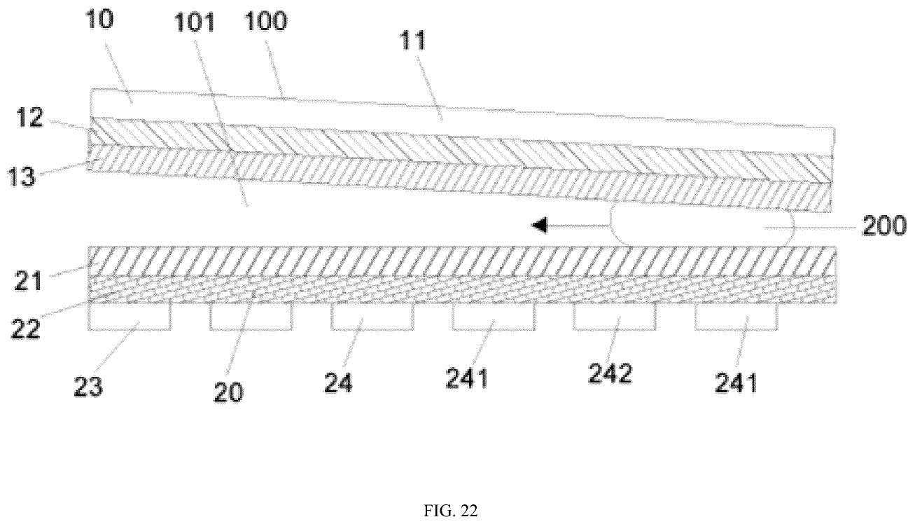

As shown in FIGS. 22-27, the particular structure of the micro-droplet generation system and the micro-droplet generation method according to Embodiment 4 of the present application are specifically illustrated in FIGS. 22-24. In Embodiment 4, the micro-droplet generating system comprises a microfluidic chip 100 consisting of an upper electrode plate 10 and a lower electrode plate 20, a fluid channel layer 101 is formed between the upper electrode plate 10 and the lower electrode plate 20. At least one of the upper electrode plate 10 and the lower electrode plate 20 forms a plurality of suction points. The suction point is used to adsorb the liquid 200, an included angle is formed between the plane where the upper electrode plate 10 is located and the plane where the lower electrode plate 20 is located, the upper electrode plate 10 is provided with a plurality of sample injection holes. The sample injection hole is positioned at the edge of the upper electrode plate 10, the sample injection hole is used for injecting liquid 200. The fluid channel layer 101 includes a first end and a second end disposed opposite each other. The height of the first end of the fluid channel layer 101 is less than the height of the second end of the fluid channel layer 101. When a liquid 200 is injected into the first end of the fluid channel layer 101 through the sample injection hole, the liquid 200 moves from the first end to the second end under the action of surface tension and forms micro-droplets 201 at the position of the suction point.

It will be appreciated that the height of the first end of the fluid channel layer 101 is less than the height of the second end of the fluid channel layer 101 means that at the first end, the distance between the upper electrode plate 10 and the lower electrode plate 20 is minimal, and at the second end, the distance between the upper electrode plate 10 and the lower electrode plate 20 is maximal.

Particularly, the included angle between the upper electrode plate 10 and the lower electrode plate 20 is larger than 0 degrees and smaller than 3 degrees at the first end, and the distance between the upper electrode plate 10 and the lower electrode plate 20 is 0 μm-200 μm.

As shown in FIGS. 22-24, The upper electrode plate 10 comprises an upper plate 11, a conductive layer 12 and a first hydrophobic layer 13 which are sequentially arranged. The lower electrode plate 20 comprises a second hydrophobic layer 21, a dielectric layer 22 and an electrode layer 23 which are sequentially arranged; The first hydrophobic layer 13 and the second hydrophobic layer 21 are oppositely arranged; The fluid channel layer 101 is formed between the first hydrophobic layer 13 and the second hydrophobic layer 21, and the electrode layer 23 comprises a plurality of electrodes 24 arranged in an array.

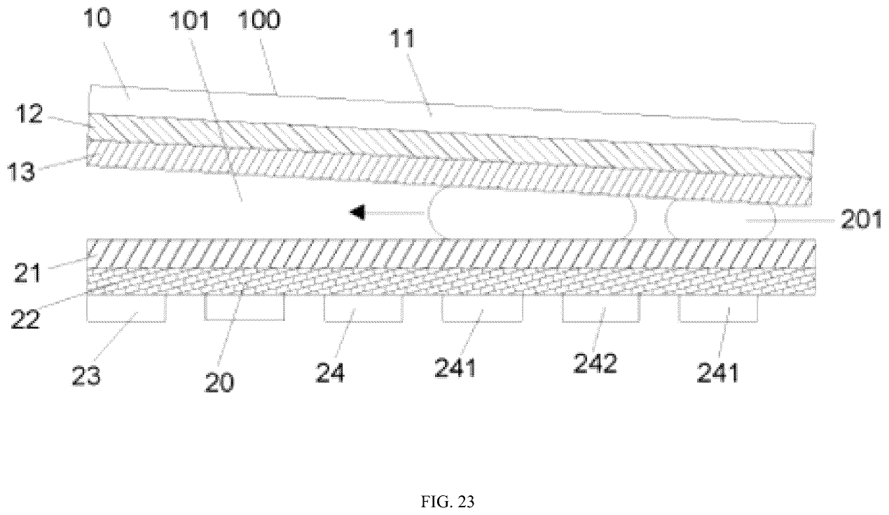

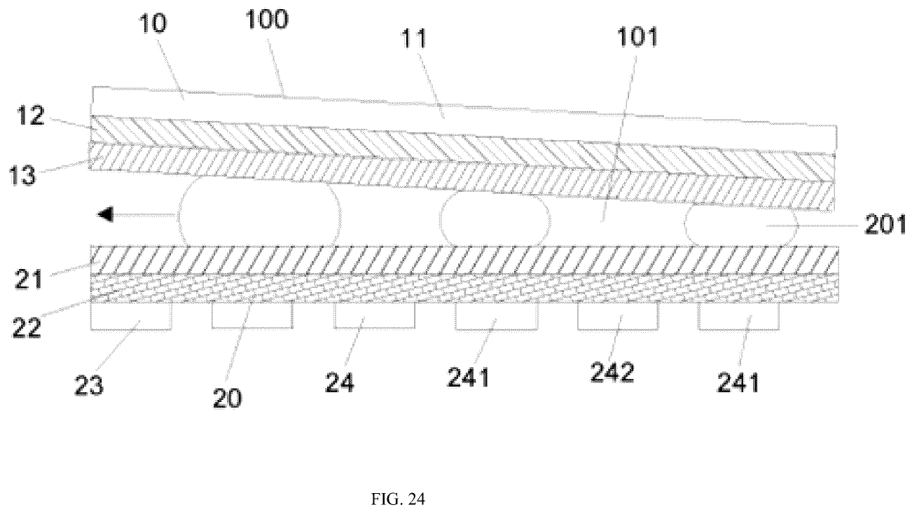

As shown in FIGS. 22-24, the application utilizes the gasket to pad one side of the upper electrode plate 10, a certain angle is formed between the upper electrode plate 10 and the lower electrode plate 20, such that the distance between the upper electrode plate 10 and the lower electrode plate 20 varies from right to left. See FIGS. 23 and 24, when droplets are injected onto the microfluidic chip 100 from the right side, the liquid 200 is moved to a place with a large gap, i.e., from the right side to the left side. At this time, a voltage is applied to the electrode layer 23, so that the surface of the corresponding electrode 24 becomes hydrophilic; when liquid 200 flows through the electrode 24 with the applied voltage, a plurality of micro-droplets 201 with the size of the single electrode 24 can be torn out; and a plurality of actuated electrodes 241 are arranged between the micro-droplets 201 at intervals, so that the higher the speed of fusion injection of the micro-droplets 201 into the liquid 200 is, the higher the success rate of splitting the micro-droplets 201 is.

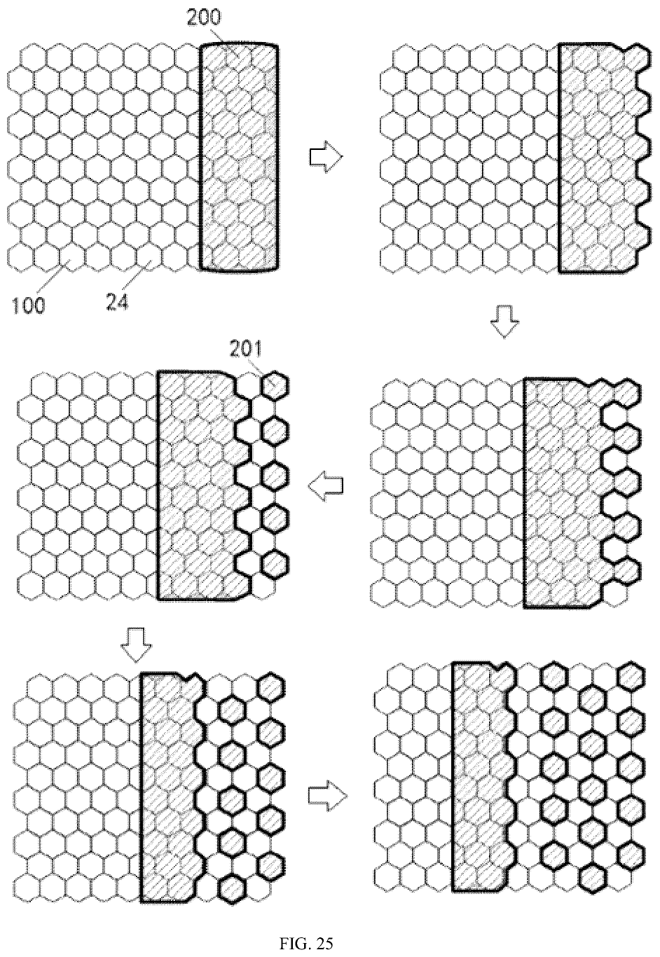

FIG. 25 is a top plan view of droplet movement, which schematically illustrates a process of a micro-droplet generation method of the micro-droplet generation system. In this embodiment of the present application, according to the invention, through the included angle formed by the upper plate 11 and the surface of the electrode 24, the large liquid drops are driven to move towards the area with a large gap, the direction of the large liquid drops is controlled through electrowetting, and the volume of the liquid drops generated by other nanoliter liquid drops can be adjusted by adjusting the size of the electrode 24, the gap distance and the size of the hydrophilic modification point through sweeping over the suction point area. That is, the micro-droplet generation system can realize rapid generation of a large number of micro-droplets 201, and can generate a large number of micro-droplets 201 of different volumes according to calculation, thereby facilitating the preparation of samples of different concentrations.

The conventional digital microfluidic method comprises controlling a large droplet to generate a micro-droplet 201, then transporting the micro-droplet 201 to a corresponding position. Injecting liquid 200 into the first end of the fluid channel layer 101, the injected liquid 200 is subjected to surface tension, the liquid 200 will gradually move from the first end to the second end, i.e., move in the arrow direction shown in FIGS. 22-24, and micro-droplets 201 are left in the fluid channel layer 101 corresponding to the suction point, so that the droplet generation time is greatly shortened.

In later experiments, the required droplet amount can be selected to complete the experiment. When the high throughput nanoliter droplet separation is completed, the corresponding experiment and detection can be carried out on the microfluidic chip 100. For example, ddPCR, dLAMP, dELISA single-cell experiments and the like can be applied to other nucleic acid detection such as isothermal amplification; meanwhile, any micro-droplet in the microfluidic chip 100 can be screened or subjected to independent experiments; and more micro-droplets can be separated or multiple groups of samples can be separated by expanding the size of the microfluidic chip 100.

It should be noted that the shape of the electrode 24 may be hexagonal or square, although the shape of the electrode 24 is not limited to hexagonal or square, and that the electrode layer 23 is an array of electrodes in the form of n*m, where n and m are both positive integers.

In this embodiment of the present application, the electrode 24 is square in shape and has a side length ranging from 50 μm to 2000 μm. It will be appreciated that the shape of the electrode 24 may be any shape or combination of any shapes.

It will be appreciated that the volume of micro-droplets 201 can be adjusted precisely by adjusting the size of electrodes 24, the gap distance between multiple electrodes 24, etc. By controlling the size of different electrodes 24, single droplets of different volumes can be rapidly generated.

In this embodiment of the present application, the upper plate 11 may be made of a glass substrate, and the thickness of the upper plate 11 may range from 0.7 mm to 1.7 mm.

In this embodiment of the present application, the material of the conductive layer 12 may be an ITO conductive layer, and the thickness of the conductive layer 12 may range from 10 nm to 500 nm.

In this embodiment of the present application, the material of the first hydrophobic layer 13 may be a fluorine-containing hydrophobic coating, and the thickness of the first hydrophobic layer 13 may range from 10 nm to 200 nm.

In this embodiment of the present application, the material of the second hydrophobic layer 21 may be a fluorine-containing hydrophobic coating, and the thickness of the second hydrophobic layer 21 may range from 10 nm to 200 nm.

In this embodiment of the present application, the material of the dielectric layer 22 may be an organic or inorganic insulating layer, and the thickness of the dielectric layer 22 may range from 50 nm to 1000 nm.

In this embodiment of the present application, the material of the electrode layer 23 may be transparent conductive glass or the thickness of the metal electrode layer 23 may range from 10 nm to 1000 nm

It will be appreciated that a suction point may be formed on the upper electrode plate 10, a suction point may be formed on the lower electrode plate 20, or both the upper electrode plate 10 and the lower electrode plate 20 may be formed.

Specifically, the suction point may be formed by different methods.

In this embodiment of the present application, the suction point may be formed by actuated electrodes 241 of the electrode layer 23, with adjacent actuated electrodes 241 being spaced apart by unactuated electrodes 242.

The suction point may also be formed by a hydrophilic point 131. Specifically, the upper electrode plate 10 is formed with an array of hydrophilic points on the side of the first hydrophobic layer 13 remote from the conductive layer 12. The hydrophilic points 131 of the hydrophilic point array are the suction points, the adjacent hydrophilic points 131 are arranged at intervals, specifically, the first hydrophobic layer 13 is subjected to hydrophilic modification, and the hydrophobic coating at the required position is treated on the first hydrophobic layer 13 by using laser or plasma to obtain the hydrophilic point array.

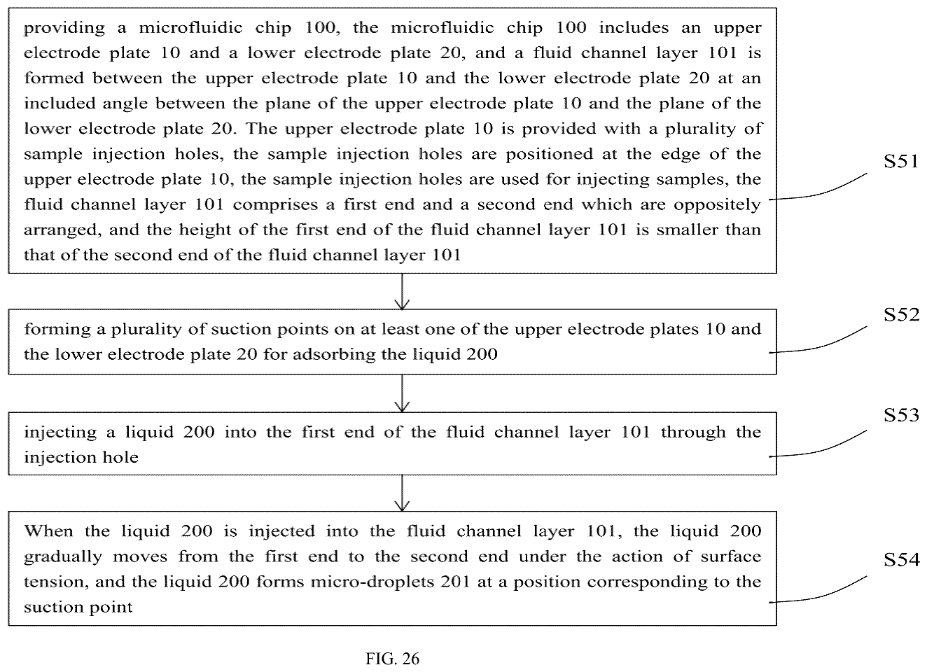

As shown in FIG. 26, the micro-droplet generation method of the micro-droplet generation system of Embodiment 4 includes the steps of:
S51, providing a microfluidic chip 100, the microfluidic chip 100 includes an upper electrode plate 10 and a lower electrode plate 20, and a fluid channel layer 101 is formed between the upper electrode plate 10 and the lower electrode plate 20 at an included angle between the plane of the upper electrode plate 10 and the plane of the lower electrode plate 20. The upper electrode plate 10 is provided with a plurality of sample injection holes, the sample injection holes are positioned at the edge of the upper electrode plate 10, the sample injection holes are used for injecting samples, the fluid channel layer 101 comprises a first end and a second end which are oppositely arranged, and the height of the first end of the fluid channel layer 101 is smaller than that of the second end of the fluid channel layer 101;
S52, forming a plurality of suction points on at least one of the upper electrode plates and the lower electrode plate 20 for adsorbing the liquid 200;
S53, injecting a liquid 200 into the first end of the fluid channel layer 101 through the injection hole;
S54. When the liquid 200 is injected into the fluid channel layer 101, the liquid 200 gradually moves from the first end to the second end under the action of surface tension, and the liquid 200 forms micro-droplets 201 at a position corresponding to the suction point.

Said step S54 is characterized by that after the described liquid 200 is injected into the described fluid channel layer 101, the described upper electrode plate 10 and the described lower electrode plate 20 are gradually approached, under the action of surface tension the described liquid 200 can be gradually moved from the described first end to the described second end, and the described liquid 200 can be formed into the form of micro-droplet 201 at the position correspondent to the suction point.

It will be appreciated that the sequence of S52 and S53 is not limited to S52 followed by S53. In particular cases, S52 may be followed by S53.

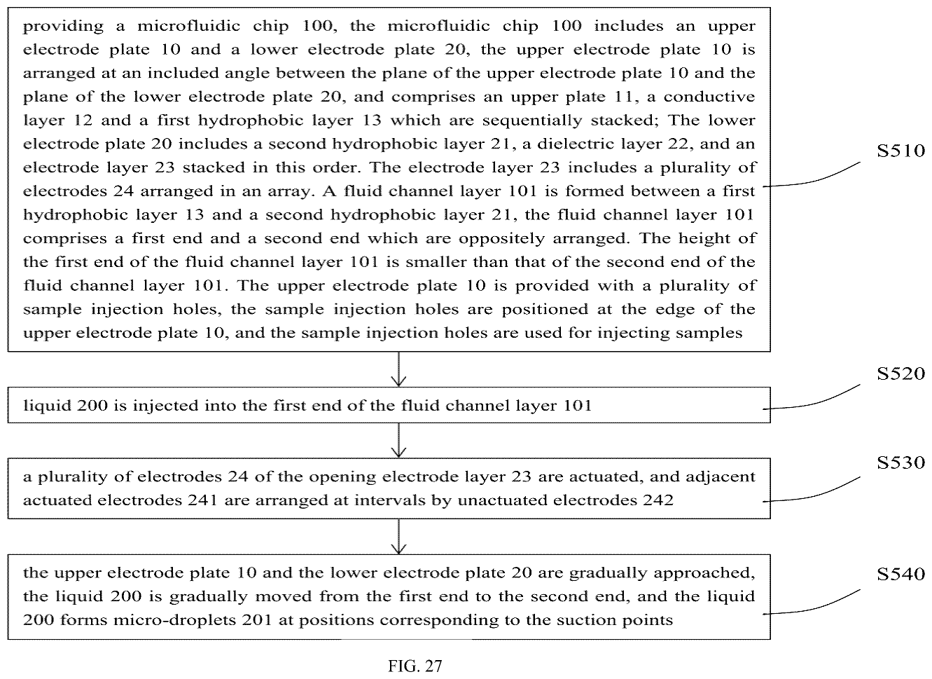

As shown in FIG. 27, the micro-droplet generation method includes the steps of:
S510, providing a microfluidic chip 100, the microfluidic chip 100 includes an upper electrode plate 10 and a lower electrode plate 20, the upper electrode plate 10 is arranged at an included angle between the plane of the upper electrode plate 10 and the plane of the lower electrode plate 20, and comprises an upper plate 11, a conductive layer 12 and a first hydrophobic layer 13 which are sequentially stacked; The lower electrode plate 20 includes a second hydrophobic layer 21, a dielectric layer 22, and an electrode layer 23 stacked in this order. The electrode layer 23 includes a plurality of electrodes 24 arranged in an array. A fluid channel layer 101 is formed between a first hydrophobic layer 13 and a second hydrophobic layer 21, the fluid channel layer 101 comprises a first end and a second end which are oppositely arranged. The height of the first end of the fluid channel layer 101 is smaller than that of the second end of the fluid channel layer 101. The upper electrode plate 10 is provided with a plurality of sample injection holes, the sample injection holes are positioned at the edge of the upper electrode plate 10, and the sample injection holes are used for injecting samples;
S520, liquid 200 is injected into the first end of the fluid channel layer 101; In this embodiment of the present application, liquid 200 is injected through a sample injection hole into the first end of the fluid channel layer 101.
S530, a plurality of electrodes 24 of the opening electrode layer 23 are actuated, and adjacent actuated electrodes 241 are arranged at intervals by unactuated electrodes 242;
S540, the upper electrode plate 10 and the lower electrode plate 20 are gradually approached, the liquid 200 is gradually moved from the first end to the second end, and the liquid 200 forms micro-droplets 201 at positions corresponding to the suction points.

It will be appreciated that S520 and S530 are not limited in order, and that S520 may be followed by S530, or S520 may be followed by S530.

The above-mentioned micro-droplet generating method, injecting a liquid 200 into the first end of the fluid channel layer 101. When the upper electrode plate 10 and the lower electrode plate 20 are gradually approached, liquid 200 is progressively moved from a first end to a second end. As the liquid 200 passes through the plurality of actuated electrodes 24, a liquid 200 forms a plurality of micro-droplets 201 in a fluid channel layer 101 at positions corresponding to the plurality of actuated electrodes 24. A large number of micro-droplets 201 can be rapidly prepared, the droplet generation time is greatly shortened, the operation process is simple and convenient, high-precision micropumps and other equipment are not needed, the system cost is reduced, the expansion capability is strong, and more micro-droplets or multiple groups of samples can be separated by expanding the size of the microfluidic chip 100.

It will be understood that, in the preparation of micro-droplets 201, the electrodes 24 of the electrode layer 23 are not fully turned on, comprising an actuated electrode 241 and an unactuated electrode 242 in order to prevent the micro-droplets 201 from bonding to each other. It will be appreciated that adjacent actuated electrodes 241 are spaced apart by unactuated electrodes 242 and that adjacent actuated electrodes 241 are spaced apart from each other by at least one unactuated electrode 242. Preferably, adjacent actuated electrodes 241 are spaced apart by two unactuated electrodes 242

It should be noted that in the step of injecting the liquid 200 into the first end of the fluid channel layer 101, the injection rate of the liquid 200 is from 1 μL/s to 10 μL/s.

The above-mentioned micro-droplet generating method, injecting a liquid 200 into the first end of the fluid channel layer 101. When the upper electrode plate 10 and the lower electrode plate 20 are gradually approached, liquid 200 is progressively moved from a first end to a second end. As the liquid 200 passes through the suction point, due to the suction action of the suction point, the micro-droplet generating method described above leaves micro-droplets 201 in the fluid channel layer 101 at positions corresponding to the suction points. A large number of micro-droplets 201 can be rapidly prepared, the droplet generation time is greatly shortened, the operation process is simple and convenient, high-precision micropumps and other equipment are not needed, the system cost is reduced, the expansion capability is strong, and more micro-droplets or multiple groups of samples can be separated by expanding the size of the microfluidic chip 100.

The above-mentioned micro-droplet generating method, by varying the size of the gap between the upper electrode plate 10 and the lower electrode plate 20 in combination with electrowetting, a plurality of micro-droplets 201 can be rapidly generated at the same time, and the volume of the micro-droplet 201 can be controlled by adjusting the gap between the upper electrode plate 10 and the lower electrode plate 20 and the size of the electrode 24. Simultaneously, the operation process is simple, the controllability is high, the liquid drops can be controlled to automatically move to leave liquid micro-droplets 201 at a designated position or area, the liquid micro-droplets 201 can be controlled to move by controlling the opening of the electrode 24, and the on-chip experiment is completed by controlling the liquid drops through electrowetting, so that the liquid micro-droplets on-chip experiment device is applicable to various micro drop-based biochemical applications. The liquid micro-droplets on-chip experiment device is simple in operation process and high in controllability.

Through actual tests, the micro-droplet generating method can rapidly split a large number of droplets, can control the movement of split droplets, and improves the splitting efficiency.

### Embodiment 5

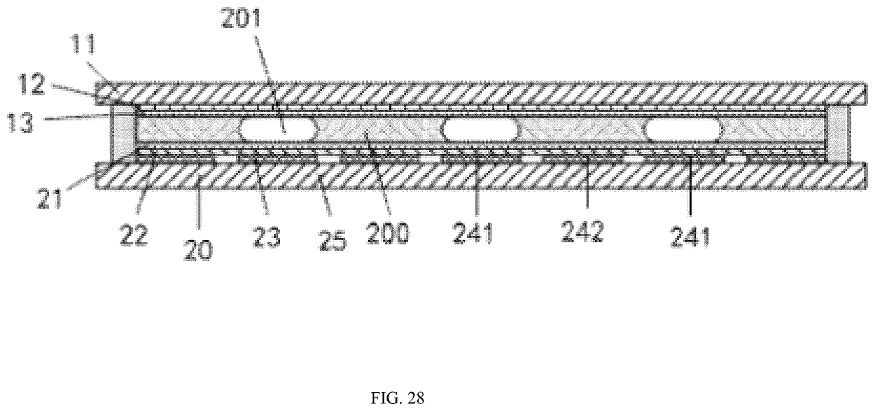

As shown in FIGS. 28-35, the particular structure of the micro-droplet generation system and micro-droplet generation method according to Embodiment 5 of the present application are specifically illustrated.

Referring to FIG. 28, the micro-droplet generation system of Embodiment 5 comprises:
A microfluidic chip comprising an upper electrode plate 10 and a lower electrode plate 20, a fluid channel layer 101 formed between the upper electrode plate and the lower electrode plate 20;
Forming a plurality of suction points in the lower electrode plate 20 for adsorbing the liquid; The liquid sample flows in the fluid channel layer 101 to form micro-droplets 201 at the position of the suction point;
The lower electrode plate 20 includes an electrode layer 23 including a plurality of electrodes 24 arranged in an array of at least two different shapes;
The suction point is formed by actuated electrodes 241 actuated by an electrode layer 23, and adjacent actuated electrodes 241 are spaced apart by unactuated electrodes 242

It should be noted that the micro-droplet generating system of the embodiment of the present application fills the fluid channel layer 101 with a liquid sample by adding the liquid sample to the fluid channel layer 101; The liquid sample flows in the fluid channel layer 101, and the liquid sample forms micro-droplets at a position corresponding to the suction point. Specifically, by controlling the opening or closing of the electrode 24 of the electrode layer 23, using electrowetting principle (when there is liquid on the electrode, and when a potential is applied to the electrode, the wettability of the solid-liquid interface at the corresponding position of the electrode can be changed, the contact angle between the droplet and the electrode interface is changed accordingly. If there is a potential difference between the electrodes in the droplet region, resulting in different contact angles, transverse driving force is generated, transversely moving the droplets on the electrode substrate). The liquid sample is attracted at the actuated electrode. The liquid sample forms a plurality of micro-droplets in the fluid channel layer at positions corresponding to the plurality of actuated electrodes. The micro-droplet generating system can greatly shorten the droplet generating time, improve the stability of droplet generation, dynamically adjust the size of the generated droplet according to requirements, is simple and convenient to operate, does not need high-precision micropumps and other equipment, reduces the system cost, has strong expansion capability, and can separate more micro-droplets or separate multiple groups of samples by expanding the microfluidic size. Further, the electrode layer 23 of the present application comprises a plurality of electrodes 24 arranged in an array of at least two different shapes. For example, a plurality of arrayed electrodes 24 may be included in combination of at least two different shapes, such as square, rectangular, hexagonal, pentagonal, triangular, circular, etc. Thus, by controlling the opening or closing of the electrode 24, it is possible to form micro-droplets 201 from large droplets on a plurality of electrodes 24 arranged in an array in one of the electrodes. The related experiment of micro-droplets can be completed on a plurality of electrodes 24 which are arranged in an array in another shape, for example, the related experiment of micro-droplets can be completed on a plurality of electrodes 24 which are arranged in a square array. For example, the related experiment of micro-droplets can be completed on a plurality of electrodes 24 which are arranged in a circular array, so that the mutual cross infection of liquid samples can be avoided.

Specifically, in the embodiments described above, adjacent actuated electrodes 241 are spaced apart by unactuated electrodes 242, preferably, at least two unactuated electrodes 242 are spaced apart between adjacent actuated electrodes 241.

In some embodiments, the electrode layer 23 comprises a plurality of square electrodes 243 arranged in an array and a plurality of hexagonal electrodes 244 arranged in an array, and the volumes of the droplets can be precisely adjusted by adjusting the sizes of the electrodes, the gap distances of the electrodes and the like. By controlling the sizes of different electrodes, can quickly form single liquid drops with different volumes, for example, by regulating the size of an electrode, the gap distance between electrodes can make the volume of liquid micro-droplets reach picoliter-level, and by controlling the position and quantity of actuated electrodes, it can implement control of position and quantity of formed liquid micro-droplets, i.e. The density of formed liquid micro-droplets can be precisely controlled.

Specifically, the square electrodes 243 and the hexagonal electrodes 244 can be arranged in a mutually crossed mode, and other arrangement modes can be selected according to actual needs.

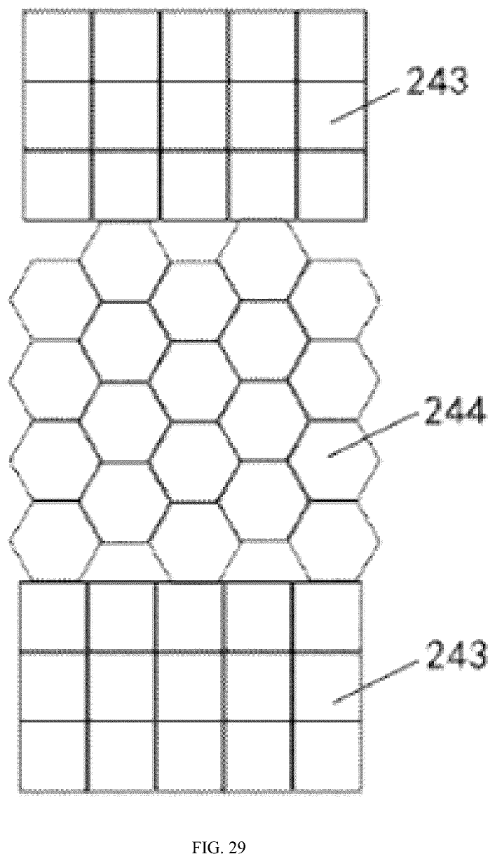

In some embodiments, referring to FIG. 29, the electrode layer 23 includes a plurality of hexagonal electrodes 244 arranged in an array and a plurality of square electrodes 243 arranged in an array on either side of the plurality of hexagonal electrodes 244 arranged in an array.

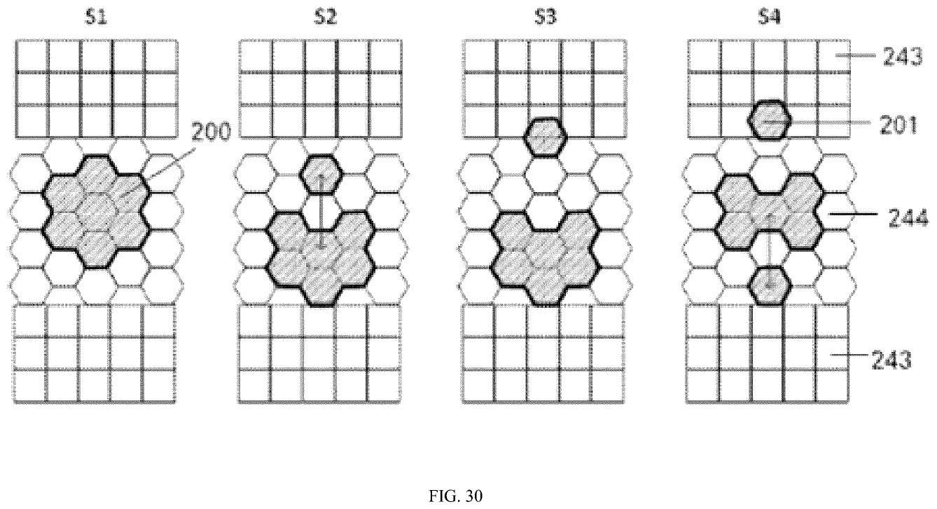

In the above-described embodiment, a plurality of hexagonal electrodes 244 arranged in an array are positioned between two square electrodes 243 arranged in an array; Referring to FIGS. 30, S1-S4, in use, a liquid 200 in the region corresponding to the hexagonal electrode 244. By controlling the opening or closing of the electrode on the hexagonal electrode 244, the liquid 200 forms micro-droplets 201, and the micro-droplets 201 are moved to the area corresponding to the square electrode 243 by controlling the opening or closing of the electrode to complete the droplet sorting process; furthermore, the related experiment of the micro-droplets can be completed in the area of the square electrode 243, so that the mutual cross infection between the micro-droplets and the large droplets can be avoided.

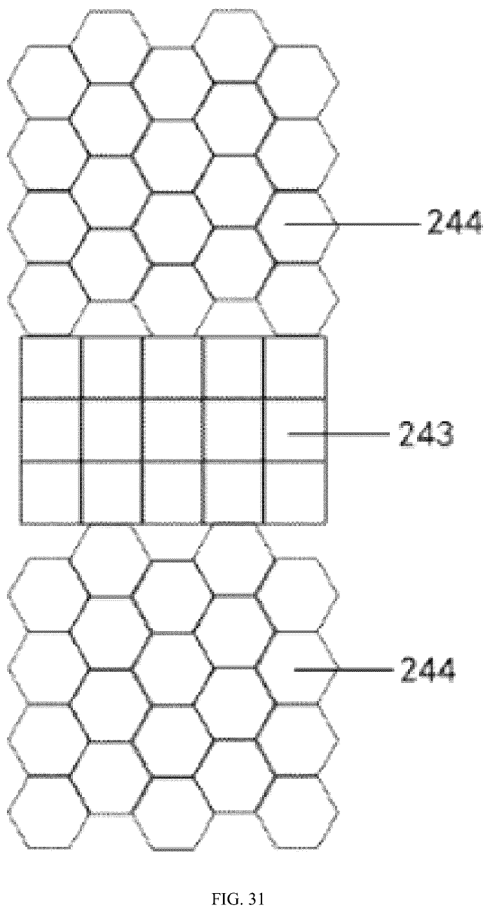

In some embodiments, referring to FIG. 31, the electrode layer 23 includes a plurality of square electrodes 243 arranged in an array and a plurality of hexagonal electrodes 244 arranged in an array on either side of the plurality of square electrodes 243 arranged in an array.

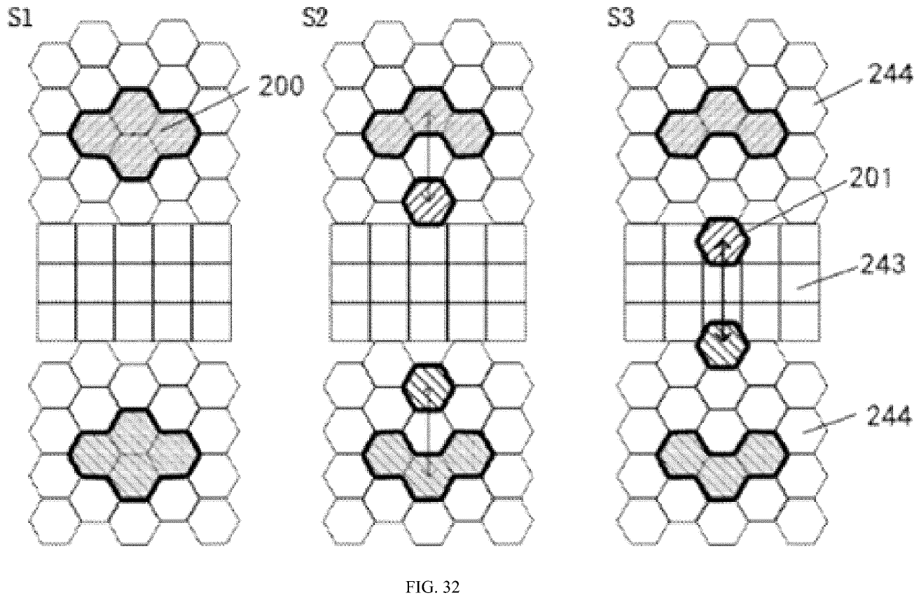

In the above-described embodiment, a plurality of square electrodes 243 arranged in an array are positioned between two hexagonal electrodes 244 arranged in an array; Referring to FIGS. 32, S1-S3, in use, a liquid 200 in the region corresponding to the hexagonal electrode 244. By controlling the opening or closing of the electrode on the hexagonal electrode 244, the liquid 200 forms micro-droplets 201, and the micro-droplets 201 are moved to the area corresponding to the square electrode 243 by controlling the opening or closing of the electrode to complete the droplet sorting process; Furthermore, the related experiment of the micro-droplets can be completed in the area of the square electrode 243, so that the mutual cross infection between the micro-droplets and the large droplets can be avoided.

Specifically, in some embodiments, the side length of the hexagonal electrode 244 is 50 μm-2 mm, the side length of the square electrode 243 is 50 μm-2 mm, and in practice, the side lengths of the hexagonal electrode 244 and the square electrode 243 can be adjusted according to user requirements.

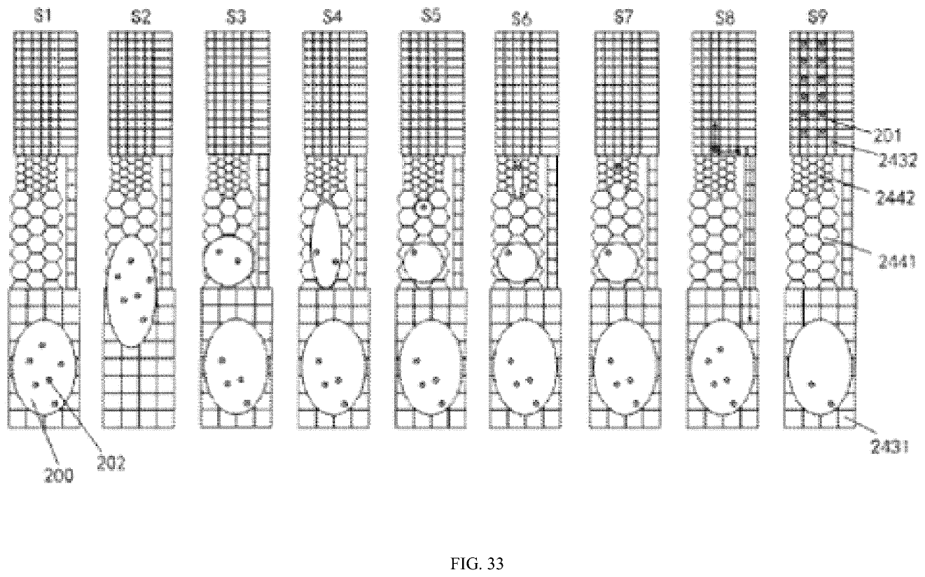

In some embodiments, referring to FIG. 33, the electrode layer 23 includes a plurality of first square electrodes 2431 arranged in an array, a plurality of first hexagonal electrodes 2441 arranged in an array, a plurality of second hexagonal electrodes 2442 arranged in an array, and a plurality of second square electrodes 2432 arranged in an array, which are sequentially connected.

In the above-mentioned embodiment, the electrode layer 23 comprises two square electrodes arranged in an array and two hexagonal electrodes arranged in an array, wherein the square electrodes are positioned between the hexagonal electrodes, and the side lengths of the square electrodes and the hexagonal electrodes are different; Specific applications in one embodiment are shown in FIGS. 33, S1-S9, a liquid 200 containing a plurality of cells 202 enters a region corresponding to the first square electrode 2431, By controlling the opening or closing of the electrodes. A liquid 200 containing a plurality of cells 202 moves to a region corresponding to the first hexagonal electrode 2441, and forms micro-droplets 201 containing a cell 202, continuing by controlling the opening or closing of the electrodes. The micro-droplets 201 containing one cell 202 are eventually moved to the region corresponding to the second square electrode 2432, so that the liquid 200 containing a plurality of cells 202 may eventually form a plurality of micro-droplets 201 containing a single cell 202 until the desired cell amount is sorted, and then the associated cell experiment is performed in the region corresponding to the second square electrode 2432.

Specifically, in the embodiment, the side length of the first square electrode 2431 is 50 μm-2 mm, the side length of the second square electrode 2432 is ⅕-½ of the side length of the first square electrode 2431, the side length of the first hexagonal electrode 2441 is 50 μm-2 mm, and the side length of the second hexagonal electrode 2442 is ⅕-½ of the side length of the first hexagonal electrode 2441.

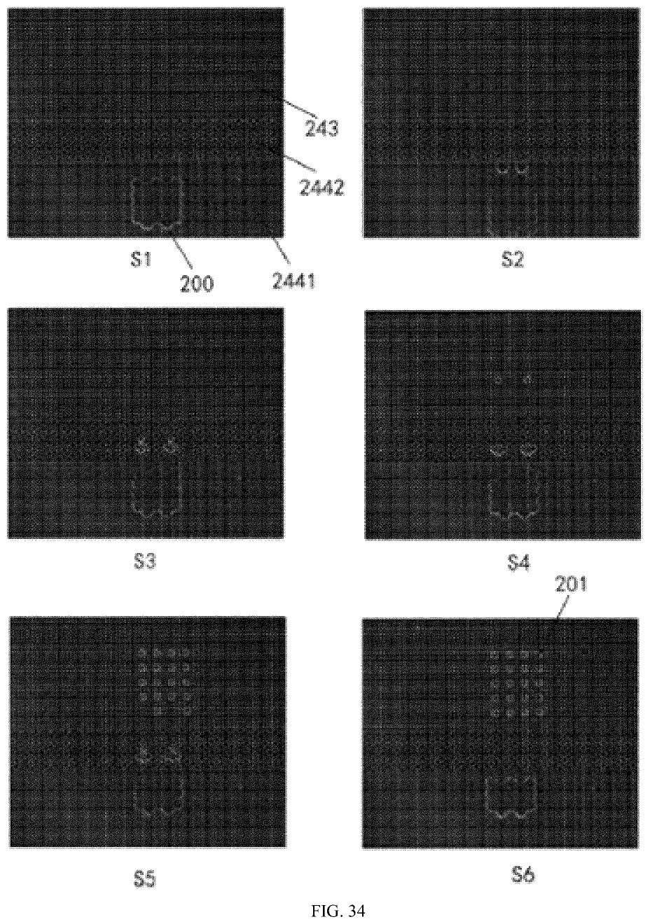

In some embodiments, referring to FIG. 34, the electrode layer 23 includes a plurality of first hexagonal electrodes 2441 arranged in an array, a plurality of second hexagonal electrodes 2442 arranged in an array, a plurality of square electrodes 243 arranged in an array, which are sequentially connected.

Specifically, S1-S6 in FIG. 34 show specific applications of the embodiments described above, liquid 200 enters the region corresponding to the first hexagonal electrode 2441. By controlling the opening or closing of the electrodes, the liquid 200 forms smaller volume droplets in the region corresponding to the second hexagonal electrode 2442, continuously controlling the opening or closing of the electrode. The droplets in the region corresponding to the second hexagonal electrode 2442 form a plurality of smaller-volume micro-droplet 201 in the region corresponding to the square electrode 243. By the method, the large droplets finally form 20 picoliter micro-droplets 201 in the region corresponding to the square electrode 243, and then related experiments of the micro-droplets 201 are carried out in the region corresponding to the square electrode 243.

Specifically, in the embodiment, the side length of the square electrode 243 is 50 μm-2 mm, the side length of the first hexagonal electrode 2441 is 50 μm-2 mm, and the side length of the second hexagonal electrode 2442 is ⅕-½ of the side length of the first hexagonal electrode 2441.

In some embodiments, with continued reference to FIG. 28, the upper electrode plate 10 comprises an upper plate 11, a conductive layer 12 and a first hydrophobic layer 13 which are sequentially stacked; The lower electrode plate 20 further comprises a second hydrophobic layer 21 and a dielectric layer 22 which are sequentially stacked; The first hydrophobic layer 13 and the second hydrophobic layer 21 are oppositely arranged, and a fluid channel layer 101 is formed between the first hydrophobic layer 13 and the second hydrophobic layer 21.

In some embodiments, the upper plate 11 has a thickness of 0.05 mm to 1.7 mm, the conductive layer 12 has a thickness of 10 nm to 500 nm, the dielectric layer 22 has a thickness of 50 nm to 1000 nm, the electrode layer 23 has a thickness of 10 nm to 1000 nm, the first hydrophobic layer 13 has a thickness of 10 nm to 100 nm, and the second hydrophobic layer 21 has a thickness of 10 nm to 100 nm.

In some embodiments, the upper plate 11 may be made of a glass substrate, the conductive layer 12 may be made of an ITO conductive layer, the dielectric layer 22 may be made of an organic or inorganic insulating material, and the electrode layer 23 may be made of a metal and its oxide conductive material.

In some embodiments, the distance between the first hydrophobic layer 13 and the second hydrophobic layer 21 is 20 μm to 200 μm, both the first hydrophobic layer 13 and the second hydrophobic layer 21 being made of a hydrophobic material, such as a hydrophobic layer made of PTFE, fluorinated polyethylene, fluorocarbon wax or other synthetic fluoropolymer or the like.

In some embodiments, the microfluidic chip further includes a sample injection hole (not shown) for injecting a liquid sample and a medium into the microfluidic chip and a sample drain hole (not shown) for discharging the liquid sample and the medium, specifically, a sample injection hole and a sample drain hole may be provided in the upper electrode plate 10 of the upper plate.

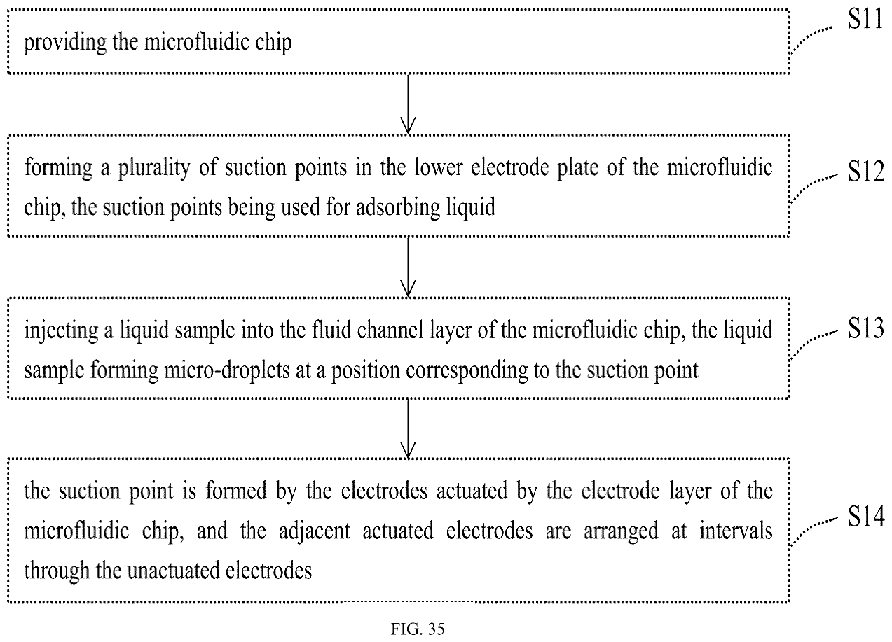

Based on the same inventive concept, the embodiment of the invention also provides a micro-droplet generation method, which is shown in FIG. 35 and comprises the following steps:
S11, providing the microfluidic chip;
S12, forming a plurality of suction points in the lower electrode plate of the microfluidic chip, the suction points being used for adsorbing liquid;
S13, injecting a liquid sample into the fluid channel layer of the microfluidic chip, the liquid sample forming micro-droplets at a position corresponding to the suction point;
S14, the suction point is formed by the electrodes actuated by the electrode layer of the microfluidic chip, and the adjacent actuated electrodes are arranged at intervals through the unactuated electrodes.

It is necessary to note that the micro-droplet generating method of the embodiment of the invention adopts the microfluidic chip to generate micro-droplets, the microfluidic chip comprises an upper electrode plate 10 and a lower electrode plate 20, and a fluid channel layer 101 is formed between the upper electrode plate 10 and the lower electrode plate 20, forming a plurality of suction points in the lower electrode plate 20 for adsorbing the liquid. The liquid sample flows in the fluid channel layer 101 to form micro-droplets 201 at the position of the suction point. The lower electrode plate 20 includes an electrode layer 23. The electrode layer 23 includes at least two electrodes 24 of different shapes arranged in an array to inject a liquid sample into the fluid channel layer, the liquid sample is attracted by the suction point, using electrowetting principles, the liquid sample is left with micro-droplets at a position corresponding to the suction point. And the micro-droplet generating method can be used for quickly preparing high-density micro-droplets, greatly shorten the droplet generating time, simple operation process, no need of high precision micropump, the cost of the system is reduced and the expansibility is strong. Further, more micro-droplets can be separated by expanding the chip size or multiple groups of samples can be separated. Since the electrode layer includes at least two electrodes of different shapes arranged in an array. By controlling the opening or closing of the electrodes, large droplets can form micro-droplets on a plurality of arrayed electrodes in one of the electrodes, and related experiments of the micro-droplets can be completed on a plurality of arrayed electrodes in the other electrodes, so that cross infection of liquid samples can be avoided.

In some embodiments, the micro-droplet generation method further includes: injecting a medium into a fluid channel layer of the microfluidic chip to fill the fluid channel layer with the medium, specifically, the medium may be air, silicone oil, mineral oil, or the like;

Injecting a liquid sample into the fluid channel layer of the microfluidic chip, the liquid sample being surrounded by a medium, the liquid sample forming micro-droplets at a position corresponding to the suction point.

### Embodiment 6

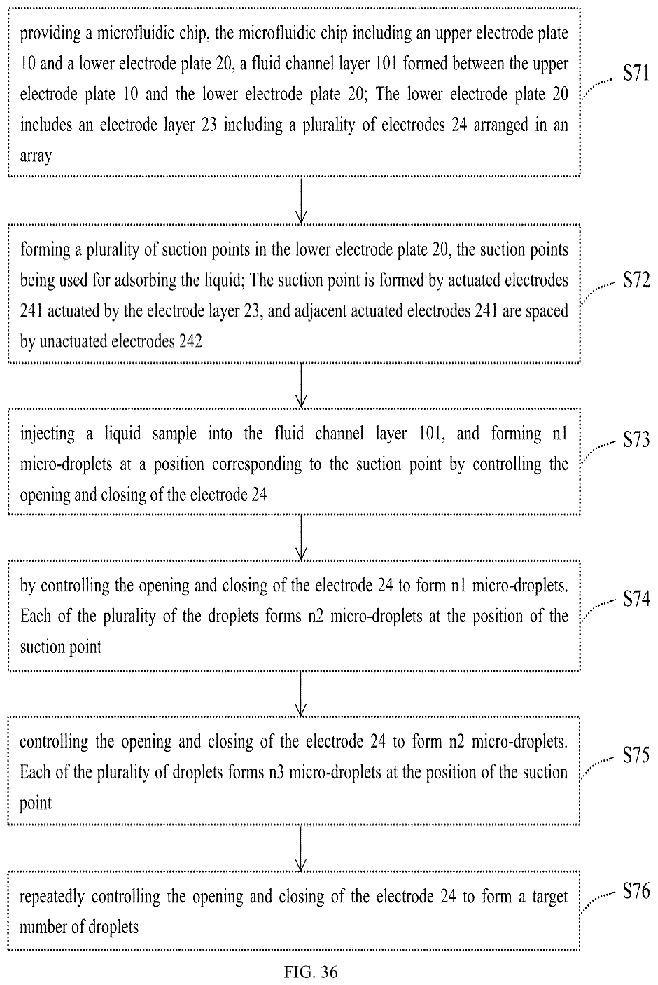

As shown in FIGS. 36-42, specific configurations and methods of micro-droplet generation of a micro-droplet generation system according to Embodiment 6 of the present application are specifically illustrated.

Referring to FIG. 36, the present application provides a method of rapidly generating micro-droplets comprising the steps of:
S71. providing a microfluidic chip, the microfluidic chip including an upper electrode plate 10 and a lower electrode plate 20, a fluid channel layer 101 formed between the upper electrode plate 10 and the lower electrode plate 20; The lower electrode plate includes an electrode layer 23 including a plurality of electrodes 24 arranged in an array;
S72, forming a plurality of suction points in the lower electrode plate 20, the suction points being used for adsorbing the liquid; The suction point is formed by actuated electrodes 241 actuated by the electrode layer 23, and adjacent actuated electrodes 241 are spaced by unactuated electrodes 242;
S73, injecting a liquid sample into the fluid channel layer 101, and forming n1 micro-droplets at a position corresponding to the suction point by controlling the opening and closing of the electrode 24;
S74, by controlling the opening and closing of the electrode 24 to form n1 micro-droplets. Each of the plurality of the droplets forms n2 micro-droplets at the position of the suction point;
S75, controlling the opening and closing of the electrode 24 to form n2 micro-droplets. Each of the plurality of droplets forms n3 micro-droplets at the position of the suction point;
S76, repeatedly controlling the opening and closing of the electrode 24 to form a target number of droplets;
Wherein n1, n2, n3 is a positive integer greater than or equal to 2.

It should be explained that the method for quickly generating the micro-droplets comprises the following steps: adding the liquid sample into the fluid channel layer 101, so that the fluid channel layer 101 is filled with the liquid sample, the liquid sample flows in the fluid channel layer 101, and the liquid sample forms the micro-droplets at the position corresponding to the suction point; Specifically, by controlling the opening or closing of the electrode 24 of the electrode layer 23, using electrowetting principle (when there is liquid on the electrode, and when a potential is applied to the electrode, the wettability of the solid-liquid interface at the corresponding position of the electrode can be changed, the contact angle between the liquid droplet and the electrode interface is changed accordingly. If there is potential difference between electrodes in the droplet region, resulting in different contact angles, transverse pushing force is generated to make the droplets move transversely on the electrode substrate), the liquid sample is attracted at the actuated electrodes, and the liquid sample forms multiple micro-droplets in the fluid channel layer corresponding to the actuated electrodes; Specifically, the suction point is formed by an actuated electrode 241 opened by an electrode layer 23. Adjacent actuated electrodes 241 are spaced apart by unactuated electrodes 242, and by controlling the opening and closing of the electrodes, the micro-droplets can be controlled to move the liquid sample to form micro-droplets by controlling the opening and closing of the electrodes 24 such that the liquid sample forms n1 micro-droplets at a position corresponding to the suction point; Further by controlling the opening and closing of the electrodes 24, the formed n1 Each of the plurality of droplets forms n2 micro-droplets at the position of the suction point; Continuously by controlling the opening and closing of the electrode 24, the formed n2 micro-droplets. Each of the plurality of droplets forms n3 micro-droplets at the position of the suction point; Repeating the cycle to control the opening and closing of the electrode 24 so that each of the plurality of micro-droplets formed continues to form a plurality of micro-droplets to obtain a target number of micro-droplets; Wherein n1, n2, n3 is a positive integer greater than or equal to 2, specifically, n1, n2, n3 may be 2, 3, 4, 5, 6, 7, 8, 9, 10, etc., and the values of n1, n2, n3 may be the same or different. I.e., the number of micro-droplets formed one after the other is not related, and the greater the number of micro-droplets formed one time, the faster the micro-droplet generation efficiency. E.g., the liquid sample forms 10 micro-droplets at a position corresponding to the suction point; Further, by controlling the opening and closing of the electrode 24, each of the formed 10 droplets is formed into 10 (obviously 8, 11, etc., specifically the required number as required) droplets at the suction point; Continuing to control the opening and closing of the electrode 24 so that each of the formed ten droplets forms ten droplets at the position of the suction point; Repeating the cycle of the control electrode 24 ultimately yields 10\hat{ }N Micro-droplets. The micro-droplet quick generation method can form a large number of micro-droplets in a short time, can quickly generate the required micro-droplet quantity, and improves the micro-droplet generation efficiency and throughput. The micro-droplet quick generation method has certain advantages in experiments (digital PCR (polymerase chain reaction), digital ELISA and generation of single cells) with huge requirements on the droplet quantity.

Specifically, in the embodiments described above, adjacent actuated electrodes 241 are spaced apart by unactuated electrodes 242, preferably, at least two unactuated electrodes 242 are spaced apart between adjacent actuated electrodes 241.

In some embodiments, a liquid sample is injected into the fluid channel layer 101, and by controlling the opening and closing of the electrode 24, the liquid sample forms 2 droplets at a location corresponding to the suction point;
Controlling the opening and closing of the electrode 24 so that each of the 2 formed droplets forms 2 droplets at the position of the suction point;
Controlling the opening and closing of the electrode 24 so that each of the 2 formed droplets forms 2 droplets at the position of the suction point.

The opening and closing of the electrode 24 are repeatedly controlled to form a target number of micro-droplets.

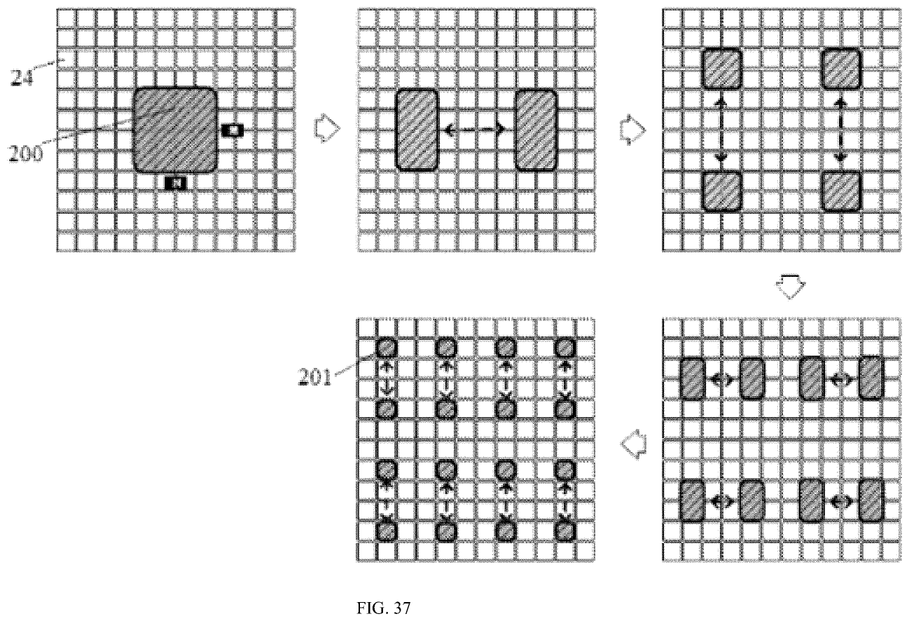

In the embodiments described above, referring to FIG. 37, the electrode 24 is square in shape, and the liquid 200 is moved by controlling the opening and closing of the electrode 24 to first form 2 droplets; And then continues by controlling the opening and closing of the electrode 24 to cause each of the 2 droplets to form 2 droplets again, at which time a total of 4 droplets are formed; Then, by controlling the opening and closing of the electrode 24 again, each of the formed droplets again forms 2 droplets, at which time a total of 8 droplets are formed; Then, by controlling the opening and closing of the electrode 24 again, each of the formed droplets again forms 2 droplets, at which time a total of 16 micro-droplets 201 are formed, and so forth, and finally 2\hat{ }N micro-droplets are formed.

In some embodiments, a liquid sample is injected into the fluid channel layer 101, and by controlling the opening and closing of the electrode 24, the liquid sample forms 3 droplets at a location corresponding to the suction point;
Controlling the opening and closing of the electrode 24 to make each of the 3 formed micro-droplets form 3 micro-droplets at the position of the suction point;
Controlling the opening and closing of the electrode 24 so that each of the 3 formed droplets forms 3 droplets at the position of the suction point;
The opening and closing of the electrode 24 are repeatedly controlled to form a target number of micro-droplets.

In the above-described embodiment, the liquid sample is moved by opening and closing the control electrode 24 to first form 3 micro-droplets, and then continues to form 3 micro-droplets again by opening and closing the control electrode 24 so that each of the 3 micro-droplets forms a total of 9 micro-droplets; Then, by controlling the opening and closing of the electrode 24 again, each of the formed droplets again forms 3 droplets, at which time a total of 27 droplets are formed; Then, by controlling the opening and closing of the electrode 24 again, each of the formed droplets again forms three droplets, at which time a total of 81 droplets are formed, and so on, is repeated to finally form 3\hat{ }N micro-droplets.

In some embodiments, a liquid sample is injected into the fluid channel layer 101, and by controlling the opening and closing of the electrode 24, the liquid sample forms 4 droplets at a location corresponding to the suction point;
Controlling the opening and closing of the electrode 24 to make each of the 4 formed micro-droplets form 2 micro-droplets at the position of the suction point;
Controlling the opening and closing of the electrode 24 so that each of the 4 formed droplets forms 2 droplets at the position of the suction point;
The opening and closing of the electrode 24 are repeatedly controlled to form a target number of micro-droplets.

In the above-described embodiment, the liquid sample is moved by opening and closing the control electrode 24 to first form 2 micro-droplets, and then continues to form 2 micro-droplets again by opening and closing the control electrode 24 so that each of the 2 micro-droplets formed forms a total of 16 micro-droplets; Then, by controlling the opening and closing of the electrode 24 again, each of the formed droplets again forms 4 droplets, at which time 64 droplets are formed in total; Then, by controlling the opening and closing of the electrode 24 again, each droplet formed again forms 4 droplets, at which time a total of 256 droplets are formed, and so on, is repeated to finally form 4\hat{ }N droplets.

In some embodiments, the shape of the electrode 24 is square or hexagonal, it will be appreciated that the hexagonal electrode may split droplets in six directions, more advantageously than in four directions of the square. The shape of the electrode can be any shape or any combination of shapes besides square or hexagon.

In some embodiments, the side length of the electrode 24 is 50 μm to 2 mm.

The volume of the droplet can be precisely adjusted by adjusting the size of the electrode and the gap distance of the electrode, by controlling the sizes of different electrodes, micro-droplets with different volumes can be quickly generated; and by controlling the positions and the number of the actuated electrodes, the positions and the number of the micro-droplets can be controlled, i.e., the density of the micro-droplets can be accurately controlled.

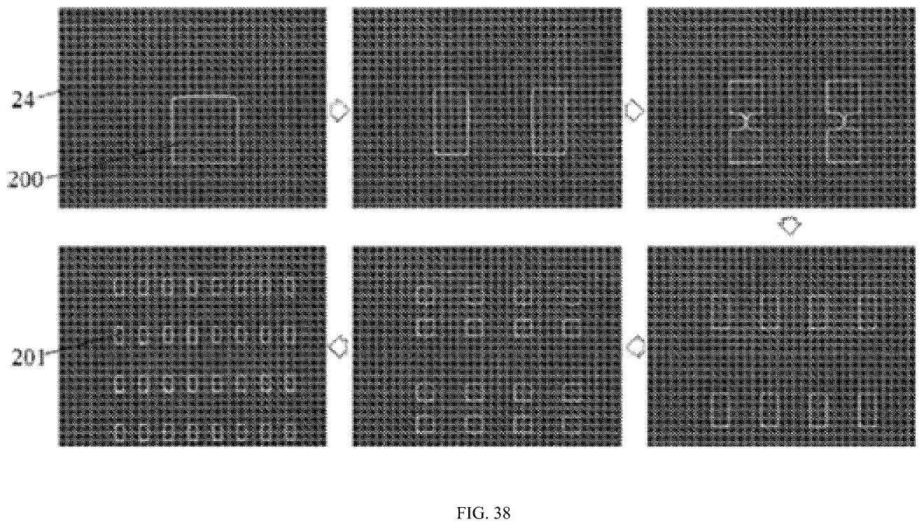

FIG. 38 illustrates an actual experimental procedure for liquid movement to generate micro-droplets in Embodiment 6 of the present application. Specifically, the electrode 24 is square, the liquid 200 forms 2 micro-droplets after moving the liquid sample by controlling the opening and closing of the electrode 24, then continues to form 2 micro-droplets again by controlling the opening and closing of the electrode 24 so that each of the formed 2 micro-droplets forms 4 micro-droplets in total; Then, by controlling the opening and closing of the electrode 24 again, each of the formed droplets again forms 2 droplets, at which time a total of 8 droplets are formed; Then, by controlling the opening and closing of the electrode 24 again, each of the formed droplets again forms 2 droplets, at which time a total of 16 droplets are formed; Then, by continuing to turn on and off the control electrode 24, each of the 2 micro-droplets formed again forms 2 micro-droplets, at which time a total of 32 micro-droplets 201 are formed.

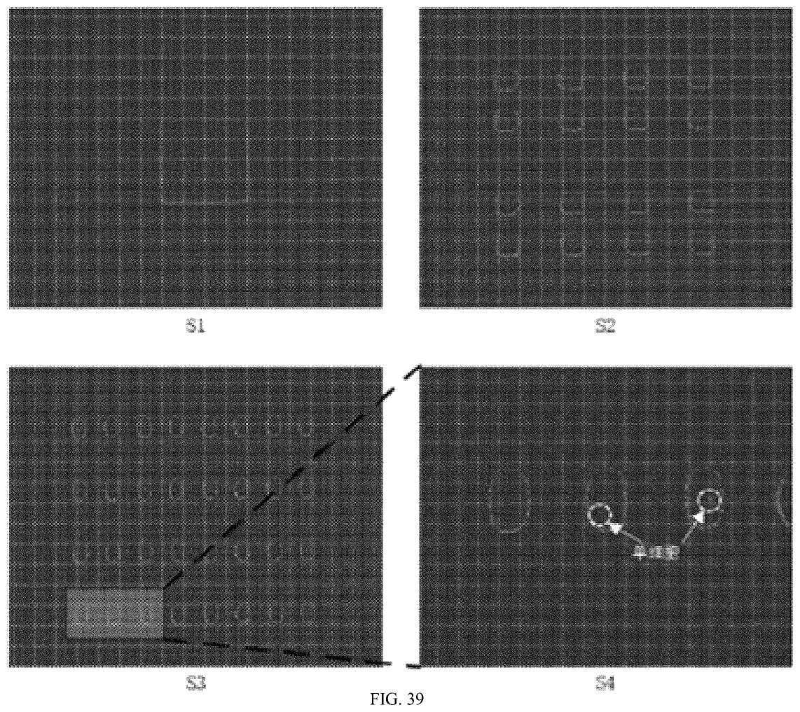

FIG. 39 illustrates the experimental procedure of the first way of moving the liquid in Embodiment 6 of the present application to generate micro-droplets of individual cells. Specifically, the electrode 24 is square, and the liquid 200 forms 16 micro-droplets after the liquid sample moves by controlling the opening and closing of the electrode 24, and then continues to form 2 micro-droplets again by controlling the opening and closing of the electrode 24 for each of the 16 micro-droplets, thereby forming 32 micro-droplets in total; To this end, a single cell assay procedure corresponding to the movement of the liquid sample of Embodiment 6 to produce micro-droplets was performed, unlike that of FIG. 38, in which the method produced droplets containing single cells.

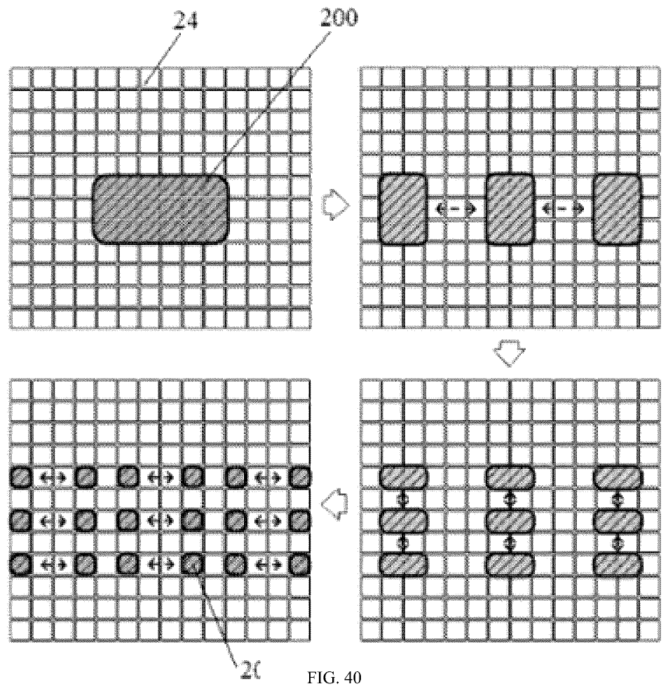

In some embodiments, referring to FIG. 40, the electrode 24 is square, and the liquid 200 forms three droplets after the liquid sample moves by controlling the opening and closing of the electrode 24, and then continues to form 3 droplets again by controlling the opening and closing of the electrode 24 so that each of the formed 2 droplets forms 9 droplets in total; Then, by controlling the opening and closing of the electrode 24 again, each of the formed droplets again forms 2 droplets, at which time 18 micro-droplets 201 are formed in total.

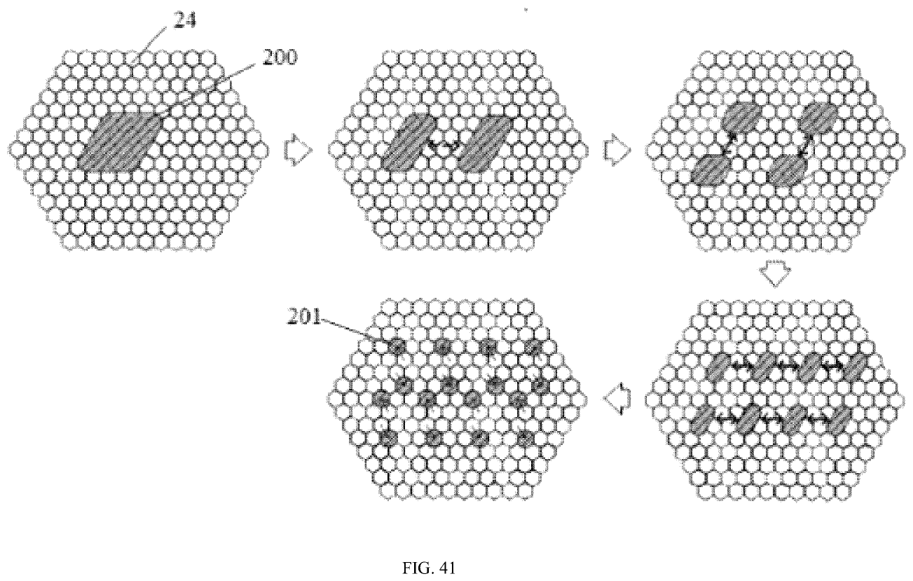

In some embodiments, Referring to FIG. 41, the electrode 24 is hexagonal in shape, and the liquid 200 is moved by controlling the opening and closing of the electrode 24 to first form 2 droplets, and then continues by controlling the opening and closing of the electrode 24 so that each of the two droplets formed again forms 2 droplets, with a total of 4 droplets being formed; Then, by controlling the opening and closing of the electrode 24 again, each of the formed droplets again forms 2 droplets, at which time a total of 8 droplets are formed; Then, by controlling the opening and closing of the electrode 24 again, each of the formed droplets again forms 2 droplets, at which time a total of 16 micro-droplets 201 are formed

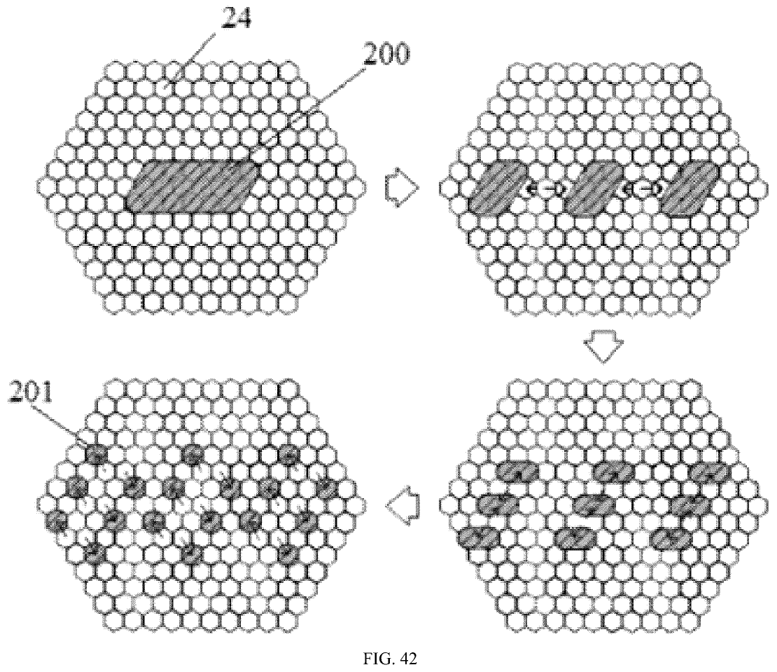

In some embodiments, Referring to FIG. 42, the electrode 24 is hexagonal in shape, and the liquid 200 is moved by controlling the opening and closing of the electrode 24 to first form 3 droplets, and then continues by controlling the opening and closing of the electrode 24 such that each of the 3 droplets formed again forms 3 droplets, with a total of 9 droplets being formed; Then, by controlling the opening and closing of the electrode 24 again, each of the formed droplets again forms 2 droplets, at which time 18 micro-droplets 201 are formed in total

The structure of the microfluidic chip of Embodiment 6 is the same as that of Embodiment 5, referring to FIG. 28, in embodiment 6, the upper electrode plate 10 comprises an upper plate 11, a conductive layer 12 and a first hydrophobic layer 13 which are sequentially stacked; The lower electrode plate 20 further comprises a second hydrophobic layer 21 and a dielectric layer 22, the second hydrophobic layer 21, the dielectric layer 22 and the electrode layer 23 are sequentially stacked; The first hydrophobic layer 13 and the second hydrophobic layer 21 are oppositely arranged, and a fluid channel layer 101 is formed between the first hydrophobic layer 13 and the second hydrophobic layer 21.

In some embodiments, the upper plate 11 has a thickness of 0.05 mm to 1.7 mm, the conductive layer 12 has a thickness of 10 nm to 500 nm, the dielectric layer 22 has a thickness of 50 nm to 1000 nm, the electrode layer 23 has a thickness of 10 nm to 1000 nm, the first hydrophobic layer 13 has a thickness of 10 nm to 200 nm, and the second hydrophobic layer 21 has a thickness of 10 nm to 200 nm.

In some embodiments, the upper plate 11 may be made of a glass substrate, the conductive layer 12 may be made of an ITO conductive layer, the dielectric layer 22 may be made of an organic or inorganic insulating material, and the electrode layer 23 may be made of a metal and its oxide conductive material.

In some embodiments, the distance between the first hydrophobic layer 13 and the second hydrophobic layer 21 is 5 μm to 600 μm, both the first hydrophobic layer 13 and the second hydrophobic layer 21 being made of a hydrophobic material, such as a hydrophobic layer made of a material such as PTFE, fluorinated polyethylene, fluorocarbon wax or other synthetic fluoropolymers.

In some embodiments, the micro-droplet generation method further comprises:
Injecting a medium into the fluid channel layer of the microfluidic chip to fill the fluid channel layer 101 with the medium, then injecting a liquid sample into the fluid channel layer of the microfluidic chip, the liquid sample being surrounded by the medium, the liquid sample forming micro-droplets at a position corresponding to the suction point.

Specifically, the medium may be air, silicone oil, mineral oil, or the like.

In some embodiments, the microfluidic chip further includes a sample injection hole (not shown) for injecting a liquid sample and a medium into the microfluidic chip and a sample drain hole (not shown) for discharging the liquid sample and the medium, specifically, the sample injection hole and the sample drain hole may be formed in the upper electrode plate 10.

In general, according to Examples 1-6 of the present application, the present application provides a micro-droplet generation method comprising the steps of:
S1, providing a microfluidic chip 100 including an upper electrode plate 10 and a lower electrode plate 20, a fluid channel layer 101 formed between the upper electrode plate 10 and the lower electrode plate 20;
S2, forming a plurality of suction points on at least one of the upper electrode plate 10 and the lower electrode plate 20, the suction points for adsorbing the liquid 200;
S3, injecting liquid 200 into the fluid channel layer 101;
S4, driving the liquid 200 to flow in the fluid channel layer 101 to form micro-droplets 201 at a plurality of suction points of the microfluidic chip 100.

According to the micro-droplet generating method and the micro-droplet generating system, can be used for quickly preparing a large number of micro-droplets, greatly shortening the droplet generating time, simple operation process, no need for high precision micropump, the cost of the system is reduced and the expansibility is strong. More micro-droplets or multiple groups of samples can be separated by expanding the size of the microfluidic chip. By controlling and adjusting the gap between the upper electrode plate and the lower electrode plate, the number, area and position of the suction points, the volume and the density of the formed micro-droplets can be accurately adjusted, so that the micro-droplet generating method and the micro-droplet generating system provided by the invention can quickly form high-density micro-droplets and can accurately control the volume and the density of the formed high-density micro-droplets.

The foregoing description of the disclosed embodiments, and numerous modifications to these embodiments will be apparent to those skilled in the art to enable those skilled in the art to make or use this application. The general principles defined herein may be practiced in other embodiments without departing from the spirit or scope of the present application, and thus, the present application is not intended to be limited to such embodiments shown herein, but is intended to conform to the widest scope consistent with the principles and novel features disclosed herein.

1.-50. (canceled)

51. A micro-droplet generating system, comprising:
a microfluidic chip and a droplet driving unit connected to the microfluidic chip, wherein the microfluidic chip comprises an upper electrode plate and a lower electrode plate, a fluid channel layer is formed between the upper electrode plate and the lower electrode plate, at least one of the upper electrode plate and the lower electrode plate forms a plurality of suction points, and the suction points are used for adsorbing liquid; wherein a liquid droplet driving unit is used for driving the liquid injected into the fluid channel layer to flow in the fluid channel layer so as to form liquid micro-droplets at a position of the suction points.

52. The micro-droplet generation system of claim 51, wherein the upper electrode plate comprises an upper plate, a conductive layer and a first hydrophobic layer which are sequentially arranged; wherein the lower plate comprises a second hydrophobic layer, a dielectric layer, an electrode layer and a substrate which are sequentially arranged, the first hydrophobic layer and the second hydrophobic layer are oppositely arranged, the fluid channel layer is formed between the first hydrophobic layer and the second hydrophobic layer, and the electrode layer comprises a plurality of electrodes arranged in an array.

53. The micro-droplet generation system of claim 52, wherein said suction points are formed by said electrodes actuated by said electrode layer, adjacent actuated electrodes being spaced apart by said electrodes not actuated.

54. The micro-droplet generating system of claim 52, wherein the upper electrode plate forms a hydrophilic point array on one side of the first hydrophobic layer far away from the conductive layer, the hydrophilic points of the hydrophilic point array are the suction points, and adjacent hydrophilic points are arranged at intervals.

55. The micro-droplet generation system of claim 52, wherein said electrode of the said electrode layer is hexagonal and/or square in shape.

56. The micro-droplet generation system of claim 52, wherein the electrode layer comprises a plurality of square electrodes arranged in an array and a plurality of hexagonal electrodes arranged in an array.

57. The micro-droplet generation system of claim 56, wherein the electrode layer comprises a plurality of hexagonal electrodes arranged in an array and a plurality of square electrodes arranged in an array on both sides of the plurality of hexagonal electrodes arranged in an array.

58. The micro-droplet generation system of claim 56, wherein the electrode layer comprises a plurality of regular-side electrodes arranged in an array and a plurality of hexagonal electrodes arranged in an array on both sides of the plurality of regular-side electrodes arranged in an array.

59. The micro-droplet generating system of claim 57, wherein a side length of the hexagonal electrode is 50 lam to 2 mm, and the side length of the square electrode is 50 lam to 2 mm.

60. The micro-droplet generating system of claim 56, wherein the electrode layer comprises a plurality of first square electrodes arranged in an array, a plurality of first hexagonal electrodes arranged in an array, a plurality of second hexagonal electrodes arranged in an array, and a plurality of second square electrodes arranged in an array which are sequentially connected.

61. The micro-droplet generating system of claim 56, wherein the electrode layer comprises a plurality of first hexagonal electrodes arranged in an array, a plurality of second hexagonal electrodes arranged in an array, and a plurality of square electrodes arranged in an array, which are sequentially connected.

62. The micro-droplet generation system of claim 60, wherein the plurality of first square electrode or a side length of the square electrode is 50 lam-2 mm, the side length of the plurality of second square electrode is ⅕-½ of the side length of the first square electrode, the side length of the first hexagonal electrode is 50 μm-2 mm, and the side length of the second hexagonal electrode is ⅕-½ of the side length of the first hexagonal electrode.

63. The micro-droplet generation system according to claim 52, wherein the liquid droplet driving unit is an electrode driving unit connected to the electrode layer and used for controlling opening and closing of the electrode of the electrode layer so as to control the flow of liquid injected into the fluid channel layer in the fluid channel layer and form liquid micro-droplets at the position of the suction points.

64. The micro-droplet generation system according to claim 52, wherein a liquid injection hole is formed in the center of the microfluidic chip; the liquid injection hole is used for injecting liquid into the fluid channel layer, the microfluidic chip is also provided with a plurality of liquid drain holes, wherein the plurality of liquid drain holes are used for discharging excess liquid from the microfluidic chip, the liquid droplet driving unit is a rotary driving unit, and the rotary driving unit is used for driving the microfluidic chip to rotate so that liquid injected into the fluid channel layer forms micro-droplets at the suction points in a spin-coating mode.

65. The micro-droplet generation system of claim 64, wherein a rotation driving unit drives the microfluidic chip to rotate at a rotation speed greater than 0 rpm and less than or equal to 1000 rpm.

66. The micro-droplet generation system of claim 64, wherein the electrode is hexagonal, a side length of the electrode is 50 μm-2 mm, and a distance between the first hydrophobic layer and the second hydrophobic layer is 5 μm-600 μm.

67. The micro-droplet generation system according to claim 52, wherein the microfluidic chip is provided with a first sample injection hole and a first sample drain hole, the first sample injection hole and the first sample drain hole are arranged on a first diagonal line of the microfluidic chip, wherein the liquid droplet driving unit includes a first micropump and a third micropump, wherein the first micropump is connected to the first sample injection hole and is used for injecting liquid into the fluid channel layer so that the fluid channel layer is filled with the liquid, and the third micropump is connected to the first sample drain hole and is used for extracting the liquid or gas flowing out of the first sample drain hole so as to form micro-droplets at the suction points.

68. The micro-droplet generation system of claim 67, wherein the microfluidic chip is also provided with a second sample injection hole and a second sample drain hole, the second sample injection hole and the second sample drain hole are arranged on a second diagonal line of the microfluidic chip, wherein the liquid droplet driving unit further includes a second micropump and a fourth micropump, wherein the second micropump is connected to the second sample injection hole and used for injecting medium into the fluid channel layer, and the fourth micropump is connected to the second sample drain hole and used for extracting excess liquid or medium flowing out of the second sample drain hole so that liquid micro-droplets are wrapped by medium formed at the position of the suction points.

69. The micro-droplet generation system of claim 67, wherein the thickness of the upper plate is 0.05 mm to 1.7 mm, the thickness of the substrate is 0.05 mm to 1.7 mm, the thickness of the conductive layer is 10 nm to 500 nm, the thickness of the dielectric layer is 50 nm to 1000 nm, the thickness of the electrode layer is 10 nm to 1000 nm, the thickness of the first hydrophobic layer is 10 nm to 200 nm, and the thickness of the second hydrophobic layer is 10 nm to 200 nm.

70. A micro-droplet generating system comprising:
a microfluidic chip consisting of an upper electrode plate and a lower electrode plate, a fluid channel layer is formed between the upper electrode plate and the lower electrode plate, at least one of said upper electrode plate and said lower electrode plate forming a plurality of suction points, the suction points are used for adsorbing liquid, an included angle is formed between the plane of the upper electrode plate and the plane of the lower electrode plate, the upper electrode plate is provided with a plurality of sample injection holes, the sample injection hole is positioned at the edge of the upper electrode plate, the sample injection hole is used for injecting liquid, said fluid channel layer comprising a first end and a second end disposed opposite each other, the height of the first end of the fluid channel layer being less than the height of the second end of the fluid channel layer, wherein when liquid is injected into the first end of the fluid channel layer through the sample injection hole, the liquid moves from the first end to the second end under the action of surface tension and forms micro-droplets at the suction points.

71. A micro-droplet generating method comprising:
providing a microfluidic chip including an upper plate and a lower plate, a fluid channel layer formed between the upper plate and the lower plate; wherein the lower plate includes an electrode layer including a plurality of electrodes arranged in an array;
forming a plurality of suction points in the lower plate, the suction points for adsorbing liquid; wherein the suction points are formed by electrodes actuated by the electrode layer, and adjacent actuated electrodes are arranged at intervals through the electrodes which are not actuated;
injecting a liquid sample into the fluid channel layer, and forming n1 droplets of the liquid sample at a position corresponding to the suction points by controlling opening and closing of the electrode;
controlling the opening and closing of the electrode to make each of the n1 micro-droplets form n2 micro-droplets at the position of the suction points;
controlling the opening and closing of the electrode to make each of the n2 micro-droplets form n3 micro-droplets at the position of the suction points; and
repeatedly controlling opening and closing of the electrodes to form a target number of micro-droplets;
wherein n1, n2, n3 are positive integers greater than or equal to 2.

72. The method of claim 71, wherein the liquid sample is injected into the fluid channel layer, and the liquid sample forms two droplets at a position corresponding to the suction points by controlling the opening and closing of the electrode;
controlling the opening and closing of the electrode to make each of the two droplets form two droplets at the position of the suction points;
controlling the opening and closing of the electrode to make each of the two formed droplets form two droplets at the position of the suction points; and
repeatedly controlling the opening and closing of the electrodes to form a target number of micro-droplets.

73. The micro-droplet generation method of claim 71, wherein the liquid sample is injected into the fluid channel layer, and the liquid sample forms three micro-droplets at a position corresponding to the suction points by controlling the opening and closing of the electrode;
controlling the opening and closing of the electrode to make each of the formed three micro-droplets form three micro-droplets at the position of the suction points;
controlling the opening and closing of the electrode to make each of the formed three micro-droplets form three micro-droplets at the position of the suction points; and
repeatedly controlling the opening and closing of the electrodes to form a target number of micro-droplets.

74. The method of claim 71, wherein the liquid sample is injected into the fluid channel layer and forms four droplets at a position corresponding to the suction points by controlling the opening and closing of the electrode;
controlling the opening and closing of the electrode to make each of the four formed droplets form four droplets at the position of the suction points;
controlling the opening and closing of the electrode to make each of the four formed droplets form four droplets at the position of the suction points; and
repeatedly controlling the opening and closing of the electrodes to form a target number of micro-droplets.

75. The micro-droplet generation method according to claim 71, wherein the electrode is square or hexagonal.

76. The micro-droplet generation method of claim 75, wherein an upper electrode plate comprises an upper plate, a conductive layer and a first hydrophobic layer which are sequentially stacked; wherein the lower plate further comprises a second hydrophobic layer and a dielectric layer, wherein the second hydrophobic layer, the dielectric layer and the electrode layer are sequentially stacked; wherein the first hydrophobic layer and the second hydrophobic layer are oppositely arranged, and the fluid channel layer is formed between the first hydrophobic layer and the second hydrophobic layer.

77. The micro-droplet generating method of claim 75, wherein a side length of the electrode is 50 lam to 2 mm.

78. The micro-droplet generation method of claim 76, wherein a distance between the first hydrophobic layer and the second hydrophobic layer is 5 μm to 600 μm.
